(19) United States
(12) Patent Application Publication
(10) Pub. No.: US 2026/0010865 A1
(43) Pub. Date: Jan. 8, 2026

(54) NAVIGATION AND DELIVERY INFORMATION PROCESSING METHOD AND APPARATUS, DEVICE, MEDIUM, AND PROGRAM PRODUCT

(71) Applicant: TENCENT TECHNOLOGY (SHENZHEN) COMPANY LIMITED, Shenzhen (CN)

(72) Inventor: Zhongyang SUN, Shenzhen (CN)

(73) Assignee: TENCENT TECHNOLOGY (SHENZHEN) COMPANY LIMITED, Shenzhen (CN)

(21) Appl. No.: 19/330,899

(22) Filed: Sep. 17, 2025

Related U.S. Application Data
(63) Continuation of application No. PCT/CN2024/101481, filed on Jun. 26, 2024.

(30) Foreign Application Priority Data
Sep. 8, 2023 (CN) 202311164259.5

(51) Int. Cl. G06Q 10/083; G01C 21/36

(52) U.S. Cl. CPC G06Q 10/0843; G01C 21/3697

(57) ABSTRACT

A navigation information processing method, apparatus, and computer-readable storage medium for coordinating vehicle navigation with item ordering and preparation. The method displays a navigation interface with an order control for generating orders during vehicle navigation operations. Order information including the navigation destination is generated and displayed based on user operations. A first duration is determined from real-time remaining travel time to the navigation destination, while a second duration is determined from real-time preparation and delivery times of the target item. When the first duration is less than or equal to the second duration, a preparation state is generated and displayed to indicate the target item is in preparation, enabling synchronized timing between arrival and item preparation.

### CROSS-REFERENCE TO RELATED APPLICATIONS

This application is a continuation application of International Application No. PCT/CN2024/101481 filed on Jun. 26, 2024 which claims priority to Chinese Patent Application No. 202311164259.5, filed with the China National Intellectual Property Administration on Sep. 8, 2023, the disclosures of each being incorporated by reference herein in their entireties.

### FIELD

The disclosure relates to the field of Internet of Vehicles, a navigation and delivery information processing method and apparatus, a device, a medium, and a program product.

### BACKGROUND

In the related art, with the development of artificial intelligence technology, the connection between automotive intelligence and various services provided by applications is becoming increasingly close.

For instance, a service type may be a food delivery service. A user may use the food delivery service through an in-vehicle terminal, with a license plate number supported as a delivery address. The user drives a vehicle to a parking lot, a delivery person may deliver the food to the parking lot, and deliver the food to the corresponding vehicle based on the license plate number; or the user uses the food delivery service through a food delivery application, schedules a pickup time, and drives the vehicle to a specified delivery location to receive the food.

However, vehicle information is dynamic, for example, a time when the vehicle arrives at the parking lot or the specified delivery location may vary depending on traffic conditions, while the food delivery service is static, for example, a food delivery time may need to be determined based on a scheduled pickup time specified by the user. Therefore, there may be a situation in which the vehicle has arrived but the order is not prepared or delivered yet, or the order has been prepared or delivered but the vehicle has not arrived yet, leading to low efficiency of order scheduling.

### SUMMARY

Provided are a navigation information processing method and apparatus, a device, a storage medium, and a program product, which can implement intelligent order management by coordinating vehicle navigation timing with item preparation and delivery schedules.

According to some embodiments, a navigation information processing method, performed by a computer device, includes: displaying a navigation interface based on a navigation operation of a vehicle, the navigation interface comprising an order control configured to generate an order for a target item; generating and displaying order information based on a user operation on the order control, the order information comprising a navigation destination inputted during the navigation operation; determining a first duration based on a real-time remaining travel time for the vehicle to arrive at the navigation destination; determining a second duration based on a real-time preparation time and delivery time of the target item; and generating and displaying a preparation state for indicating that the target item is in preparation, based on the first duration being less than or equal to the second duration.

According to some embodiments, a navigation information processing apparatus, includes: at least one memory configured to store program code; and at least one processor configured to read the program code and operate as instructed by the program code, the program code including: display code configured to cause at least one of the at least one processor to display a navigation interface based on a navigation operation of a vehicle, the navigation interface comprising an order control configured to generate an order for a target item; order code configured to cause at least one of the at least one processor to generate and display order information based on a user operation on the order control, the order information comprising a navigation destination inputted during the navigation operation; first determination code configured to cause at least one of the at least one processor to determine a first duration based on a real-time remaining travel time for the vehicle to arrive at the navigation destination; second determination code configured to cause at least one of the at least one processor to determine a second duration based on a real-time preparation time and delivery time of the target item; and preparation code configured to cause at least one of the at least one processor to generate and display a preparation state for indicating that the target item is in preparation, based on the first duration being less than or equal to the second duration.

According to some embodiments, a non-transitory computer-readable storage medium, storing computer code which, when executed by at least one processor, causes the at least one processor to at least: display a navigation interface based on a navigation operation of a vehicle, the navigation interface comprising an order control configured to generate an order for a target item; generate and display order information based on a user operation on the order control, the order information comprising a navigation destination inputted during the navigation operation; determine a first duration based on a real-time remaining travel time for the vehicle to arrive at the navigation destination; determine a second duration based on a real-time preparation time and delivery time of the target item; and generate and display a preparation state for indicating that the target item is in preparation, based on the first duration being less than or equal to the second duration.

### BRIEF DESCRIPTION OF THE DRAWINGS

To describe the technical solutions in embodiments of this application more clearly, the following briefly introduces the accompanying drawings required for describing embodiments. Apparently, the accompanying drawings in the following descriptions merely show some embodiments of this application, and a person of ordinary skill in the art may still derive other drawings based on these accompanying drawings without creative efforts.

FIG. 1 is a structural block diagram of a computer system according to some embodiments.

FIG. 2 is a schematic diagram of an application scenario for order information processing according to some embodiments.

FIG. 3 is a flowchart of an order information processing method according to some embodiments.

FIG. 4 is a flowchart of an order information processing method according to some embodiments.

FIG. 5 is a flowchart of an order information processing method according to some embodiments.

FIG. 6 is a flowchart of an order information processing method according to some embodiments.

FIG. 7 is a flowchart of an order information processing method according to some embodiments.

FIG. 8 is a flowchart of an order information processing method according to some embodiments.

FIG. 9 is a flowchart of an order information processing method according to some embodiments.

FIG. 10 is a schematic diagram of a navigation interface according to some embodiments.

FIG. 11 is a schematic diagram of a navigation interface according to some embodiments.

FIG. 12 is a schematic diagram of a navigation interface according to some embodiments.

FIG. 13 is a schematic diagram of a navigation interface according to some embodiments.

FIG. 14 is a schematic diagram of a navigation interface according to some embodiments.

FIG. 15 is a schematic diagram of a navigation interface according to some embodiments.

FIG. 16 is a schematic diagram of a navigation interface according to some embodiments.

FIG. 17 is a flowchart of an order information processing method according to some embodiments.

FIG. 18 is a flowchart of an order information processing method according to some embodiments.

FIG. 19 is a block diagram of an order information processing apparatus according to some embodiments.

FIG. 20 is a structural block diagram of a computer device according to some embodiments.

### DESCRIPTION OF EMBODIMENTS

To make the objectives, technical solutions, and advantages of this application clearer, the following further describes embodiments of this application in detail with reference to the accompanying drawings.

Exemplary embodiments are described in detail herein, and examples of the exemplary embodiments are shown in the accompanying drawings. When the following descriptions relate to the accompanying drawings, unless indicated otherwise, same numbers in different accompanying drawings represent same or similar elements. The implementations described in the following exemplary embodiments do not represent all implementations consistent with this application. Instead, they are merely examples of apparatuses and methods consistent with some aspects related to this application as recited in the appended claims.

The terms used in this application are merely for describing embodiments, but are not intended to limit this application. The terms “a”, “an”, and “the” of singular forms used in this application and the appended claims are also intended to include a plurality of forms, unless otherwise specified in the context clearly. The term “and/or” refers to and includes any or all possible combinations of at least one associated listed item.

Although the terms first, second, and the like may be used in this application to describe various information, the information is not limited to the terms. These terms are merely used to distinguish information of the same type. For example, within the scope of this application, a first parameter may also be referred to as a second parameter, and similarly, the second parameter may also be referred to as the first parameter. Depending on a context, the term “if” as used herein may be interpreted as “when . . . ” or “upon . . . ” or “in response to determining”.

In this application, a prompt interface, a pop-up window, or voice prompt information may be displayed before and during the collection of the related data (such as data related to vehicle navigation, various types of services, order payment, an address, and positioning) of the user. The prompt interface, the pop-up window, or the voice prompt information is configured for prompting the user that the relevant data of the user is currently being collected. In this application, only after a confirmation operation performed by the user on the prompt interface or the pop-up window is obtained, the relevant operation of obtaining the relevant data of the user starts to be performed. Otherwise (for example, when the confirmation operation performed by the user on the prompt interface or the pop-up window is not obtained), the relevant operation of obtaining the relevant data of the user ends, for example, the relevant data of the user is not obtained. In other words, all user data collected in this application is collected with consent and authorization of the user, the collection, use, and processing of user-related data may comply with relevant laws, regulations, and standards of relevant countries and regions.

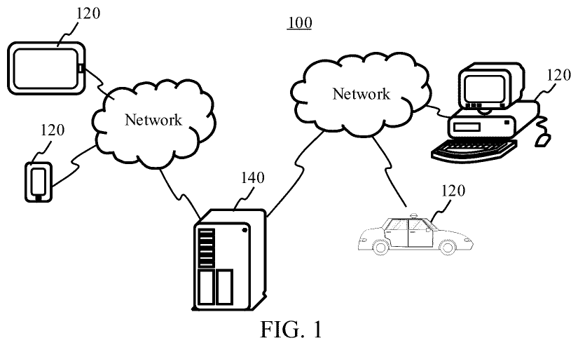

FIG. 1 is a structural block diagram of a computer system 100 according to some embodiments. The computer system may be implemented as a system architecture of an order information processing method. The computer system 100 includes a terminal 120 and a server 140.

The terminal 120 may be an electronic device such as a mobile phone, a tablet computer, an in-vehicle terminal (in-vehicle infotainment system), a wearable device, a personal computer (PC), an unmanned reservation terminal, an intelligent voice interaction device, an aircraft, a driving recorder, a vehicle control device, or a mobile terminal communicatively connected to a vehicle.

A client of a target application may be installed and run on the terminal 120. The target application may be an application configured for providing a navigation function and various types of services (for example, at least one of a food delivery service, a chauffeur service, an errand service, a car wash service, or a car rental service); or the target application may be an application configured to provide a navigation function. The target application includes a service application redirect button, and by tapping the service application redirect button, it can navigate from the target application to another service application that provides another service function. The target application and the service application are both logged in with the same user account and are capable of data interoperability.

Forms of the target application and the service application are not limited in this application, and include but are not limited to an application (APP), a mini program, and the like that are installed in the terminal 120, or may be in a webpage form.

The server 140 may be an independent physical server, or a server cluster or a distributed system composed of a plurality of physical servers, or may be a cloud server that provides a cloud computing service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The server 140 may be a back-end server of the foregoing target application, and is configured to provide a background service for a client of the target application.

A cloud technology is a hosting technology that unifies a series of resources such as hardware, software, and a network in a wide area network or a local area network, to implement data computing, storage, processing, and sharing. A background service of a technical network system needs a large quantity of computing and storage resources, such as a video website, an image website, and more portal websites. With the development and application of the Internet industry, each item may have identification flag and may be transmitted to the background system for logic processing. Data of different levels is processed separately. Various industry data needs powerful system support, and this be implemented only through cloud computing.

In some embodiments, the server may be implemented as a node in a blockchain system. Blockchain is a new application mode of a computer technology such as distributed data storage, point-to-point transmission, consensus mechanism, and an encryption algorithm. The blockchain is essentially a decentralized database, and is a string of a data block generated in a cryptographic manner. Each data block contains information about a batch of network transactions, which is used to verify validity of the information (anti-counterfeiting) and generate a next block. The blockchain may include a blockchain underlying platform, a platform product service layer, and an application service layer.

The terminal 120 and the server 140 may communicate with each other by using a network, for example, a wired or wireless network.

In the order information processing method provided in the embodiments of this application, operations may be performed by a computer device, and the computer device is an electronic device having data calculation, processing, and storage capabilities. The solution implementation environment shown in FIG. 1 is used as an example. The order information processing method may be performed by the terminal 120 (for example, the client of the target application that is installed and run on the terminal 120 performs the order information processing method), or performed cooperatively through interaction between the terminal 120 and the server 140. This is not limited in this application.

A person skilled in the art may learn that there may be more or fewer terminals 120. For example, there may be only one terminal 120, or there may be dozens, hundreds, or more of terminals 120. A quantity and a device type of the terminals 120 are not limited in some embodiments.

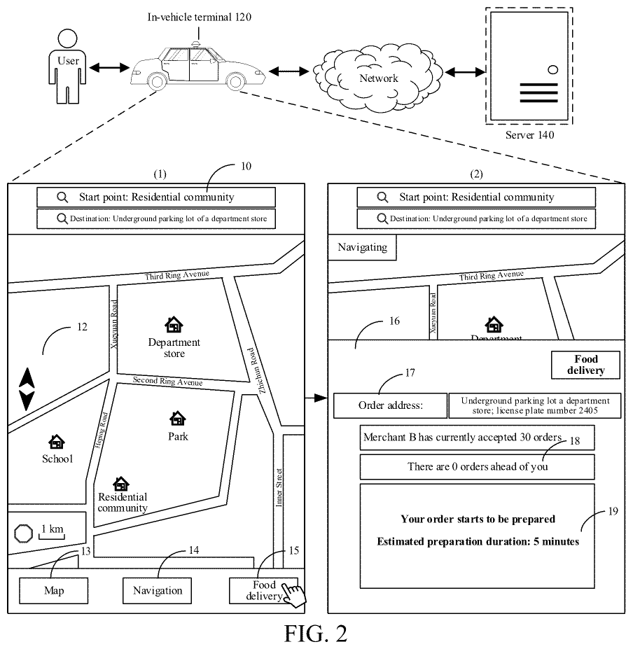

FIG. 2 is a schematic diagram of an order information processing method according to some embodiments. The method may be applied in technical fields and application scenarios such as a map, traffic, autonomous driving, Internet of Vehicles, an in-vehicle scenario, an intelligent vehicle, driver assistance, and various types of services (a food delivery service, a chauffeur service, an errand service, a car wash service, and a car rental service), to improve efficiency of order scheduling.

For example, if the method is applied to an in-vehicle scenario, where the item is a food delivery item, and the service type is a food delivery service, an order generation sub-area is a food delivery ordering area, a service product is a food delivery product, and a service address (for example, a delivery address of the item) is a food delivery address.

The terminal 120 is an in-vehicle terminal 120, and may be at least one of a driving recorder, a vehicle controller, and a mobile terminal communicatively connected to a vehicle. A client of the target application runs is installed and run on the in-vehicle terminal 120. The target application is configured for providing a navigation function and a food delivery service function. The navigation function includes at least one of map navigation, voice navigation, or real-time traffic notifications. The food delivery service function includes at least one of food delivery order placement, food delivery information prompts, or food delivery recommendations.

The order information processing method according to some embodiments may be performed by a computer device. The computer device may be the terminal 120 shown in FIG. 1 or the in-vehicle terminal 120 shown in FIG. 2, and may be performed independently, or may be implemented through interaction with the server 140. Operations of the order information processing method may be briefly described as follows.

1. The computer device displays a navigation interface in response to a navigation operation of a vehicle, the navigation interface including an order control, the order control being configured to generate an order related to a target item.

For example, the computer device displays the navigation interface in response to the navigation operation of the vehicle, the navigation interface includes the order control configured to trigger the display of the order generation sub-area, to generate the order related to the target item. For example, the order generation sub-area is a food delivery ordering area configured for placing an order for food delivery products.

As shown in the schematic diagram (1) in FIG. 2, a user starts the target application configured to provide the navigation function, and the computer device displays the navigation interface in response to the navigation operation of the vehicle. In some embodiments, the navigation interface includes a navigation information input area 10, a map 12, a map button 13, a navigation button 14, and a food delivery button 15. In some embodiments, the food delivery button 15 is the order control, and the food delivery ordering area is displayed by tapping the food delivery button 15.

The user may select or input a navigation start point and a navigation destination in the navigation information input area 10, where the navigation start point is “Residential community”, and the navigation destination is “Underground parking lot of a department store”. The user may view the map 12 by tapping the map button 13. The user may initiate navigation from the navigation start point “Residential community” to the navigation destination “Underground parking lot of a department store” by tapping the navigation button 14. Before navigation is initiated or during the navigation process, the food delivery ordering area may be displayed by tapping the food delivery button 15, and an order for the food delivery product is placed in the food delivery ordering area. The food delivery address is the navigation destination.

2. The computer device generates and displays order information of the order in response to an operation of the user on the order control, the order information including the navigation destination inputted during the navigation operation.

For example, the computer device displays order information of a food delivery order in response to an order placement operation in the food delivery ordering arca. The food delivery address in the order information includes the navigation destination.

As shown in the schematic diagram (2) in FIG. 2, a food delivery ordering area 16 is displayed on the navigation interface of the computer device. In the food delivery ordering area 16, after editing the food delivery order, the user completes order placement, and the computer device displays the order information of the food delivery order in response to the order placement operation in the food delivery ordering arca 16.

The order information includes a destination address of the order, for example, a food delivery address. The food delivery address is the navigation destination “Underground parking lot of a department store”. In some embodiments, the destination address also includes a license plate number “2405” of a vehicle, so that a delivery person may deliver the food delivery product to the vehicle of the user.

3. The computer device generates and displays a first order state in response to a first duration being less than or equal to a second duration, the first order state being configured for indicating that the target item is in a preparation state, the first duration being determined based on a real-time remaining duration for the vehicle to arrive at the navigation destination, and the second duration being determined based on a real-time delivery duration of the target item.

For example, the first duration being less than or equal to the second duration is an order trigger condition. In response to satisfying the order trigger condition, the computer device displays the first order state, specifically, item preparation prompt information. The item preparation prompt information is configured for indicating that the target item in the order is in the preparation state, for example, indicating that the food delivery product in the food delivery order are in the preparation state, and may also include a preparation duration of the target item. The real-time delivery duration of the target item includes the preparation duration and a delivery duration of the target item.

When determining that the first duration is less than or equal to the second duration, the computer device determines that the order trigger condition is satisfied. As shown in the schematic diagram (2) in FIG. 2, in response to satisfying the order trigger condition, the computer device displays the first order state, for example, item preparation prompt information 19 “Your order starts to be prepared. Estimated preparation duration: 5 minutes”, to indicate that the food delivery product in the food delivery order is in the preparation state, and also indicate that a preparation duration of the food delivery product is 5 minutes.

In some embodiments, the computer device may also display merchant information 18, where the merchant information 18 includes merchant order acceptance information “Merchant B has currently accepted 30 orders”, and also includes merchant queue information “There are O orders ahead of you”, to indicate a current workload of the merchant.

In conclusion, in the order information processing method provided in some embodiments, an example in which the service type is the food delivery service is used. The computer device can combine the preparation and delivery of the food delivery product in the food delivery order with the real-time remaining duration for the vehicle to arrive at the navigation destination, to avoid a situation in which the vehicle has arrived but the food is not prepared or delivered yet or a situation in which the food has been prepared or delivered but the vehicle has not arrived yet. This improves the food delivery service function of the navigation software, improves time consistency between the delivery of the target item and the navigation destination, and avoids additional processing of abnormal orders by the user, thereby improving the data processing speed of the navigation software and the order processing efficiency of the entire scheduling system.

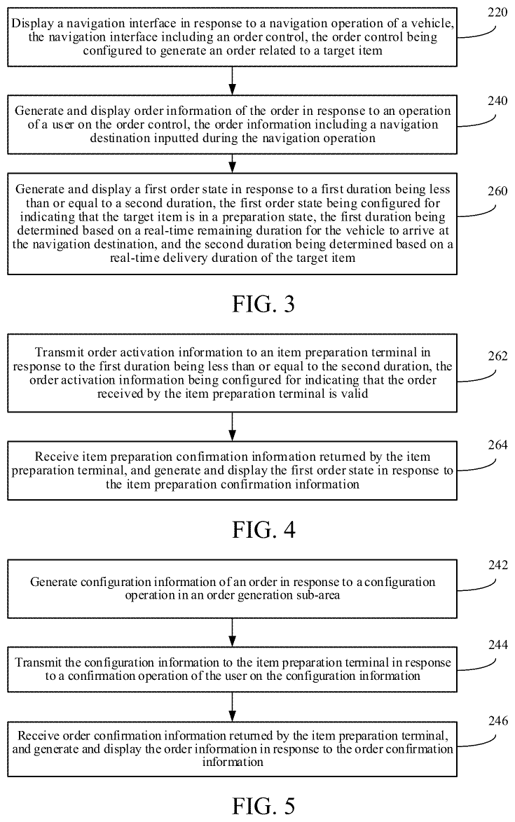

FIG. 3 is a flowchart of an order information processing method according to some embodiments. An example in which the method is applied to a computer device is used for description. The computer device may be the terminal 120, the in-vehicle terminal 120, or the server 140 shown in FIG. 1 and FIG. 2. The method may include operation 220, operation 240, and operation 260.

Operation 220: Display a navigation interface in response to a navigation operation of a vehicle, the navigation interface including an order control, the order control being configured to generate an order related to a target item.

The navigation operation refers to an operation of performing navigation using the computer device.

The navigation interface is a user interface displayed by the computer device in response to the navigation operation.

In some embodiments, the navigation operation includes a map viewing operation from a navigation start point to a navigation destination. In this case, a user has not confirmed to initiate navigation and is only viewing a navigation route. The navigation interface displays at least one navigation route from the navigation start point to the navigation destination.

In some embodiments, the navigation operation includes a navigation initiation operation from a navigation start point to a navigation destination. In this case, the user has initiated navigation and may drive the vehicle to the navigation destination. The navigation interface displays navigation traffic conditions from the navigation start point (or current location point) to the navigation destination.

An order generation sub-area is a display sub-area in the navigation interface, and may be configured for generating orders, for example, placing an order for service products. In some embodiments, the order generation sub-area may be displayed at the bottom position or the top position of the navigation interface.

In some embodiments, the service type includes at least one of a food delivery service, a chauffeur service, an errand service, a car wash service, or a car rental service. The service product may be at least one of a physical product or a virtual product. For example, if the service type is the food delivery service, the service product is a physical product (food delivery product). If the service type is the chauffeur service, the service product is a virtual product (mileage order). In some embodiments, it supports placing an order for the service product in the order generation sub-area before and after the user initiates navigation (during the navigation process).

In some embodiments, before the user initiates navigation, when an order for the service product is placed in the order generation sub-area, the computer device displays the navigation interface, where the navigation interface includes the order generation sub-area, and the order generation sub-area also includes a search box. Then, in response to a search operation in the order generation sub-area, the computer device displays merchants corresponding to the search operation and various service products that the merchants can provide, thereby assisting the user in placing an order for the service product.

In some embodiments, after the user places an order, the user may initiate navigation next, and the computer device may also display navigation recommendation information. The navigation recommendation information is configured for recommending a service address corresponding to the service order as the navigation destination. This facilitates delivering the service product to the vehicle of the user.

After the user places an order, although the navigation recommendation information is displayed, the user may still select a navigation destination independently, where the navigation destination may be different from the service address. The computer device determines, in response to a destination selection operation, a navigation destination indicated by the destination selection operation; and displays order cancellation prompt information in response to a distance between the navigation destination and the service address being greater than a preset threshold, the order cancellation prompt information being configured for indicating cancellation of the service order.

In some embodiments, after the user initiates navigation, when the user places an order for the service product in a service ordering area, in this case, the computer device has determined the navigation destination, and the computer device displays the navigation interface, the navigation interface including the service ordering area. The service ordering area displays the merchant corresponding to the navigation destination, merchants around the navigation destination, and related information of various service products that each merchant can provide, thereby assisting the user in placing an order for the service product.

For example, assuming that the navigation destination is a merchant A, the merchant A and various service product that can be provided by the merchant A may be directly displayed in the service ordering area. Assuming that the navigation destination is a department store, and the department store includes a plurality of merchants, the service ordering area may recommend and display to the user merchants in the department store based on a preference of the user, along with various service products that each merchant can provide. The preference of the user may be determined based on information such as merchants and merchant types corresponding to historical service orders of the user.

In some embodiments, the navigation interface includes the order control, which is a service button, such as the food delivery button 15 in the schematic diagram (1) of FIG. 2. The computer device displays the service ordering area in the navigation interface in response to a trigger operation on the service button, the service ordering arca being configured for placing an order for the service product.

In some embodiments, the computer device navigates from the navigation interface to the service ordering interface in response to a trigger operation on the service button, the service ordering interface being configured for placing an order for the service product.

The trigger operation includes at least one of a tap operation, a double-tap operation, a touch operation, a long-press operation, or a swipe operation.

Based on this, the service ordering area can be displayed only when the user may place an order for the service product, effectively preventing the service ordering arca from excessively occupying a display area of the navigation interface, thereby avoiding adverse impact on navigation.

Operation 240: Generate and display order information of the order in response to an operation of a user on the order control, the order information including a navigation destination inputted during the navigation operation.

The operation of the user on the order control refers to an operation of the user to complete a transaction on the target item, for example, an operation of the user to add service products that may be purchased this time to a shopping cart and complete the payment. In this case, the order generation sub-area includes a transaction control for the user to complete the transaction on the target item.

In some embodiments, the service ordering area includes a payment button, and the order placement operation includes a trigger operation on the payment button. The trigger operation includes at least one of a tap operation, a double-tap operation, a touch operation, a long-press operation, or a swipe operation. The computer device confirms the service order placement in response to the trigger operation on the payment button in the service ordering area, and displays order information of the service order.

The order information refers to detailed order information corresponding to the service order.

In some embodiments, the order information includes at least one of a service address (also referred to as an order address and a delivery address), a name of a merchant, a name, a type, a quantity, and a unit price of service products, a total price of the order, whether the order starts to be prepared, whether the order starts to be delivered, an order queue status, an estimated preparation duration, an estimated delivery duration, estimated time of arrival, an order number, order placement time, or a note.

In some embodiments, the service address in the order information is set to the navigation destination. In some embodiments, the service address in the order information also includes a license plate number. In other words, the user may drive the vehicle to the navigation destination, and the merchant may deliver the service order to the vehicle at the navigation destination.

Operation 260: Generate and display a first order state in response to a first duration being less than or equal to a second duration, the first order state being configured for indicating that the target item is in a preparation state, the first duration being determined based on a real-time remaining duration for the vehicle to arrive at the navigation destination, and the second duration being determined based on a real-time delivery duration of the target item.

In some embodiments, when the first duration is less than or equal to the second duration, it is determined that an order trigger condition is satisfied. The order trigger condition refers to a condition for informing the merchant of the may prepare the service product in the service order; or the order trigger condition refers to a preparation/production condition of the service product in the service order.

The first duration is determined based on the real-time remaining duration for the vehicle to arrive at the navigation destination.

In some embodiments, the computer device determines the estimated time of arrival (ETA) of the vehicle at the navigation destination based on at least one of a distance between the navigation start point and the navigation destination, real-time traffic conditions between the navigation start point and the navigation destination, historical driving data, real-time weather conditions, and driving proficiency of the driver, and subtracts the current time from the estimated time of arrival, to obtain the real-time remaining duration for the vehicle to arrive at the navigation destination.

In some embodiments, the first duration is equal to the real-time remaining duration for the vehicle to arrive at the navigation destination. In some embodiments, a time difference between the first duration and the real-time remaining duration after the vehicle arrives at the navigation destination is less than a threshold, for example, the first duration is close to the real-time remaining duration.

For example, a shorter distance between the navigation start point and the navigation destination indicates better real-time traffic conditions between the navigation start point and the navigation destination, better real-time weather conditions, and higher driving proficiency of the driver, meaning that the estimated time of arrival is closer. For example, the computer device first determines the maximum estimated time of arrival based on the minimum driving speed specified for a navigation path between the navigation start point and the navigation destination and the distance between the navigation start point and the navigation destination. Then, the computer device may shorten the maximum estimated time of arrival proportionally based on the driving proficiency of the driver.

The second duration is determined based on the real-time delivery duration of the target item, including a duration for preparing the target item (referred to as a preparation duration) and a duration for delivering the target item (referred to as a delivery duration).

In some embodiments, the merchant determines a preparation duration and a delivery duration that correspond to the service order based on at least one of a type and a quantity of service products in the service order, a total quantity of received service orders, proficiency in preparing the service product, or a workload of the merchant, and transmits the preparation duration and the delivery duration that correspond to the service order to the computer device through an item preparation terminal, such as a merchant terminal.

In some embodiments, the second duration is equal to a sum of the preparation duration and the delivery duration that correspond to the service order, for example, second duration=preparation duration+delivery duration.

In some embodiments, the second duration is equal to a weighted sum of the preparation duration, a preparation duration weight, the delivery duration, and a delivery duration weight that correspond to the service order, for example, second duration=preparation duration x preparation duration weight+delivery duration x delivery duration weight.

In some embodiments, the second duration is equal to a sum of the preparation duration and the delivery duration that correspond to the service order and a preset buffer duration, for example, second duration=preparation duration+delivery duration+buffer duration.

In some embodiments, the second duration is equal to a weighted sum of the preparation duration, the preparation duration weight, the delivery duration, the delivery duration weight, the preset buffer duration, and a buffer duration weight that correspond to the service order, for example, second duration=preparation duration x preparation duration weight+delivery duration x delivery duration weight+buffer duration x buffer duration weight.

The buffer duration may be set by the user based on an actual situation, and is an adjustable parameter. For example, if the user has another planned or unexpected arrangement during driving that may consume time, the buffer duration may be set based on the unexpected arrangement. The buffer duration may also be configured for preventing the preparation duration and the delivery duration that correspond to the service product from being set excessively short, thereby avoiding a situation in which the merchant starts to prepare the service product only when the user is about to arrive at the navigation destination, and preventing excessive waiting time for the user at the navigation destination.

For example, in response to satisfying the order trigger condition, the computer device displays item preparation prompt information. The item preparation prompt information is configured for indicating that the service product in the service order is in the preparation state (also referred to as a stock preparation state or an execution state).

In some embodiments, after the computer device displays the item preparation prompt information in operation 260, the user may further perform a secondary confirmation to avoid problems caused by changes in the user's schedule or an unexpected new plan. The computer device transmits secondary confirmation information to the item preparation terminal in response to a confirmation operation on the first order state, to indicate that the user has reconfirmed the preparation of the target item.

For example, the computer device transmits confirmation information to the merchant terminal in response to the confirmation operation on the item preparation prompt information, the confirmation information being configured for confirming the preparation of the service product in the service order. The confirmation operation includes at least one of a tap operation, a double-tap operation, a touch operation, a long-press operation, or a swipe operation on a confirmation button in order prompt information.

In some other embodiments, when the user has a changed schedule or an unexpected new plan, the user may also choose to notify the merchant to postpone the preparation of the service product. The computer device also transmits delay information to the merchant terminal in response to a delay operation on the item preparation prompt information, the delay information being configured for indicating a postponement in the preparation of the service product in the service order. The delay operation includes at least one of a tap operation, a double-tap operation, a touch operation, a long-press operation, or a swipe operation on a delay button in the order prompt information.

In conclusion, according to the order information processing method provided in the embodiments of this application, a computer device displays a navigation interface in response to a navigation operation of a vehicle, the navigation interface including an order control, the order control being configured to generate an order related to a target item; generates and displays order information of the order in response to an operation of a user on the order control, the order information including a navigation destination inputted during the navigation operation; and generates and displays a first order state in response to a first duration being less than or equal to a second duration, the first order state being configured for indicating that the target item is in a preparation state, the first duration being determined based on a real-time remaining duration for the vehicle to arrive at the navigation destination, and the second duration being determined based on a real-time delivery duration of the target item. Based on this, the preparation and delivery of the service product in the service order can be combined with the real-time remaining duration for the vehicle to arrive at the navigation destination, so that it is possible to avoid a situation in which the vehicle has arrived but the service product is not prepared or delivered yet or the service product has been prepared or delivered but the vehicle has not arrived yet, thereby improving efficiency of order scheduling.

FIG. 4 is a flowchart of an order information processing method according to some embodiments.

In some embodiments, for example, operation 260 is replaced with operation 262 and operation 264.

Operation 262: Transmit order activation information to an item preparation terminal in response to the first duration being less than or equal to the second duration, the order activation information being configured for indicating that the order received by the item preparation terminal is valid.

In some embodiments, in response to the order trigger condition being satisfied, the order activation information is transmitted to the merchant terminal, to indicate that the order received by the merchant terminal is valid, and that the target item in the order may start to be prepared.

In some embodiments, the order activation information may be at least one of voice information, text information, or ringtone prompt information.

Operation 264: Receive item preparation confirmation information returned by the item preparation terminal, and generate and display the first order state in response to the item preparation confirmation information.

The item preparation confirmation information is information returned by the merchant terminal to the computer device, and is configured for indicating that the merchant corresponding to the merchant terminal confirms receipt of the order activation information and starts to prepare the service product in the service order.

In some embodiments, the item preparation confirmation information may be at least one of voice information, text information, or ringtone prompt information.

For example, the computer device displays the first order state, for example, the item preparation prompt information, in response to receiving the item preparation confirmation information returned by the merchant terminal.

In some embodiments, the computer device may periodically check whether the order trigger condition is satisfied. Operation 262 may be implemented as operation 262-1, operation 262-2, and operation 262-3.

Operation 262-1: Obtain the first duration and the second duration based on a preset interval.

For example, the computer device obtains the first duration and the second duration based on the preset interval.

The preset interval is determined based on at least one of the following:
a preset time interval;
a preset driving mileage interval; or
order queue information generated by the item preparation terminal, for example, order queue information of the merchant corresponding to the merchant terminal.

In some embodiments, the preset time interval may be determined based on the estimated time of arrival of the vehicle at the navigation destination. A value of the time interval is in positively correlated with a driving duration corresponding to the estimated time of arrival. A shorter driving duration indicates a shorter time interval. For example, assuming that the preset time interval is 5 minutes, the computer device obtains the first duration and the second duration every 5 minutes.

In some embodiments, the preset driving mileage interval may be determined based on a distance between the navigation start point of the vehicle and the navigation destination. A length of the driving mileage interval is in positively correlated with the distance, and a shorter distance indicates a smaller driving mileage interval. For example, assuming that the preset driving mileage interval is 3 km, the computer device obtains the first duration and the second duration each time the computer device travels 3 km.

In some embodiments, the order queue information includes a quantity of first service orders ahead of the service order and a quantity of second service orders behind the service order. In response to receiving the order queue information transmitted by the merchant terminal, the computer device triggers obtaining of the first duration and the second duration each time the quantity of first service orders decreases by one.

In some embodiments, the computer device determines the preset interval based on the quantity of first service orders. The value of the preset interval is in positively correlated with the quantity of first service orders. A smaller quantity of first service orders indicates a smaller preset interval, for example, a faster frequency of obtaining the first duration and the second duration.

The computer device receives the order queue information transmitted by the item preparation terminal; determines, in response to the order queue information, whether the item preparation terminal receives a new order after receiving the order; and triggers obtaining of the first duration and the second duration when determining that the item preparation terminal receives the new order.

For example, the computer device determines, in response to receiving the order queue information transmitted by the merchant terminal and based on the quantity of second service orders, whether the merchant corresponding to the merchant terminal receives a new service order after receiving the service order; and triggers obtaining of the first duration and the second duration when determining that the merchant receives the new service order.

Operation 262-2: Determine, based on the first duration and the second duration, whether the order trigger condition is satisfied.

Operation 262-3: Transmit the order activation information to the merchant terminal in response to the order trigger condition being satisfied.

The computer device compares the first duration with the second duration, to determine whether the order trigger condition is satisfied. When the first duration is less than or equal to the second duration, the order trigger condition is satisfied. Then, the computer device transmits the order activation information to the merchant terminal in response to the order trigger condition being satisfied.

In the foregoing embodiment, the merchant prepares the service product only when the order trigger condition is satisfied, which can improve the efficiency of order scheduling, and avoid to some extent a situation in which the vehicle has arrived but the service product is not prepared or delivered yet or the service product has been prepared or delivered but the vehicle has not arrived yet.

FIG. 5 is a flowchart of an order information processing method according to some embodiments.

In some embodiments, in response to the operation of the user on the order control, the order generation sub-area, also referred to as an order editing area, is displayed on the navigation interface. The user performs a series of editing operations in the order generation sub-area, determines a service product to be ordered, and then completes order placement in the order generation sub-area. In some embodiments, operation 240 is replaced with operation 242, operation 244, and operation 246.

Operation 242: Generate configuration information of the order in response to a configuration operation in the order generation sub-area.

The configuration operation refers to an operation of editing content of each option in the order in the order generation sub-area.

The configuration information refers to various content information selected by the user through the configuration operation.

In some embodiments, the configuration information includes at least one of a service address, a name of a merchant, a name, a type, and a quantity of service products, or a note.

Operation 244: Transmit the configuration information to the item preparation terminal in response to a confirmation operation of the user on the configuration information.

The confirmation operation of the user on the configuration information includes the order placement operation, for example, an operation of paying fees required for the order.

In some embodiments, the computer device transmits the configuration information to the merchant terminal in response to the order placement operation.

Operation 246: Receive order confirmation information returned by the item preparation terminal, and generate and display the order information in response to the order confirmation information.

In some embodiments, the merchant confirms acceptance of the service order through the merchant terminal, which is briefly referred to as order acceptance, and the computer device displays the order information of the service order in response to the merchant terminal accepting the order.

The order information includes at least one of a service address, a name of a merchant, a name, a type, a quantity, and a unit price of service products, a total price of the order, whether the order starts to be prepared, whether the order starts to be delivered, an order queue status, an estimated preparation duration, an estimated delivery duration, estimated time of arrival, an order number, order placement time, or a note.

The following embodiments describe two manners for placing a service order. In an actual scenario, one of the manners may be used or the two manners may be combined. In manner 1, operation 242 includes operation 310, operation 312, operation 314, and operation 316, and operation 244 includes operation 318. In manner 2, operation 242 includes operation 320, operation 322, and operation 324, and operation 244 includes operation 326.

### Manner 1

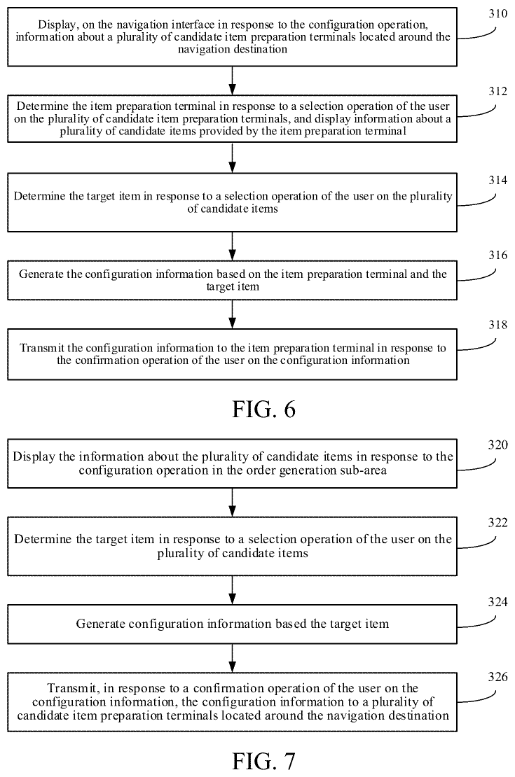

FIG. 6 is a flowchart of an order information processing method according to some embodiments. In some embodiments, the user may specify a merchant, and specify a service product to be ordered. After the order is placed, the computer device transmits the order to the merchant terminal specified by the user, and the merchant provides a preparation service and a delivery service of the service order.

Operation 310: Display, on the navigation interface in response to the configuration operation, information about a plurality of candidate item preparation terminals located around the navigation destination.

In some embodiments, the service address is the navigation destination, each candidate item preparation terminal corresponds to one candidate merchant, and the candidate merchant is at least one merchant located around the navigation destination. Being located around refers to being within a preset distance range around the navigation destination.

A size of the preset distance range may be set based on an actual technical requirement, for example, may be set based on at least one of a quantity of delivery persons around the navigation destination or a quantity of historical orders of the navigation destination. In one example, it may be set to 5 km. In some embodiments, the computer device displays, in response to the configuration operation in the order generation sub-area, a plurality of candidate merchants located around the navigation destination.

Operation 312: Determine the item preparation terminal in response to a selection operation of the user on the plurality of candidate item preparation terminals, and display information about a plurality of candidate items provided by the item preparation terminal.

In this operation, a selected merchant is determined in response to a merchant selection operation on the plurality of candidate merchants.

The merchant selection operation refers to an operation of selecting a merchant for order placement from the plurality of candidate merchants.

In some embodiments, the merchant selection operation includes at least one of a tap operation, a double-tap operation, a touch operation, a long-press operation, or a swipe operation. For example, the computer device determines the selected merchant in response to the merchant selection operation on the plurality of candidate merchants, and displays information about a plurality of candidate service products provided by the selected merchant.

Operation 314: Determine the target item in response to a selection operation of the user on the plurality of candidate items.

In this operation, a selected service product is determined in response to a product selection operation on the plurality of candidate service products provided by the merchant.

The product selection operation refers to an operation of selecting a service product to be ordered from the candidate service products.

In some embodiments, the product selection operation includes at least one of a tap operation, a double-tap operation, a touch operation, a long-press operation, or a swipe operation.

Operation 316: Generate the configuration information based on the item preparation terminal and the target item.

In this operation, the configuration information of the service order is determined based on the selected merchant and service product.

For example, the computer device determines the configuration information of the service order based on the merchant and the service product. In some embodiments, the configuration information includes at least one of a service address, a name of a merchant, a name, a type, and a quantity of service products, or a note.

Operation 318: Transmit the configuration information to the item preparation terminal in response to the confirmation operation of the user on the configuration information.

In this operation, the configuration information is transmitted to the merchant terminal corresponding to the selected merchant in response to the order placement operation. After confirming the order acceptance, the merchant may prepare the service product when the order trigger condition is satisfied.

### Manner 2

FIG. 7 is a flowchart of an order information processing method according to some embodiments. In some embodiments, the user may specify the service product to be ordered, but specify no merchant when placing the order. The computer device may transmit the service order to the plurality of merchants located around the navigation destination, allowing the merchants to grab the order. The preparation service and the delivery service of the service order are provided by the merchant that successfully grabs the order.

Operation 320: Display the information about the plurality of candidate items in response to the configuration operation in the order generation sub-area.

In this operation, the candidate service product is at least one service product recommended by the computer device to the user.

The computer device determines the at least one service product based on types of service products corresponding to historical orders of the user. In some embodiments, the candidate service product is at least one service product that the merchants located around the navigation destination can provide.

Operation 322: Determine the target item in response to a selection operation of the user on the plurality of candidate items.

In this operation, a selected service product is determined in response to a product selection operation on the plurality of candidate service products.

The product selection operation refers to an operation of selecting a service product to be ordered from the plurality of candidate service products.

In some embodiments, the product selection operation includes at least one of a tap operation, a double-tap operation, a touch operation, a long-press operation, or a swipe operation.

Operation 324: Generate configuration information based on the target item.

In this operation, the configuration information of the service order is determined based on the selected service product.

In some embodiments, the configuration information includes at least one of a service address, a name, a type, and a quantity of service products, or a note.

Operation 326: Transmit, in response to a confirmation operation of the user on the configuration information, the configuration information to a plurality of candidate item preparation terminals located around the navigation destination, a candidate item preparation terminal matching a type of the target item being determined as an item preparation terminal, or among the plurality of candidate item preparation terminals, a candidate item preparation terminal that first returns the order confirmation information being determined as an item preparation terminal.

In some embodiments, the computer device transmits, in response to the order placement operation, the configuration information to candidate merchant terminals respectively corresponding to the plurality of candidate merchants located around the navigation destination. The plurality of candidate merchant terminals participate in order grabbing. In other words, each candidate merchant terminal confirms the received configuration information, and the server determines, based on a preset rule, the candidate merchant terminal that successfully grabs the order. For example, according to a time-priority preset rule, the candidate merchant terminal that first confirms the configuration information is considered to have successfully grabbed the order.

In some embodiments, the computer device determines a type of the service product included in the service order based on the configuration information of the service order. The computer device transmits, in response to the order placement operation, the configuration information to candidate merchant terminals located around the navigation destination and that correspond to candidate merchants matching the type of the service product. In this case, the merchant terminal in operation 246 is the candidate merchant terminal that successfully grabs the order among the candidate merchant terminals. The computer device displays the order information of the service order in response to the merchant terminal that successfully grabs the order accepting the order.

The foregoing two embodiments may also be combined. In other words, the computer device transmits, in response to the order placement operation, the configuration information to a plurality of candidate merchant terminals located around the navigation destination and that correspond to the candidate merchants matching the type of the service product, and then the plurality of candidate merchant terminals participate in order grabbing.

For example, if the user places an order for a box of mineral water, and a supermarket is capable of providing the mineral water, the computer device transmits configuration information corresponding to this service order to supermarket terminals corresponding to a plurality of supermarkets located around the navigation destination, and rather than to terminals corresponding to clothing stores. The plurality of supermarkets may participate in order grabbing through the supermarket terminals, and the computer device displays the order information of the service order in response to the supermarket terminal that successfully grabs the order accepting the order.

In the foregoing embodiment, two manners for placing a service order are provided. During actual application, selection may be performed based on an actual technical requirement, thereby improving flexibility of order scheduling.

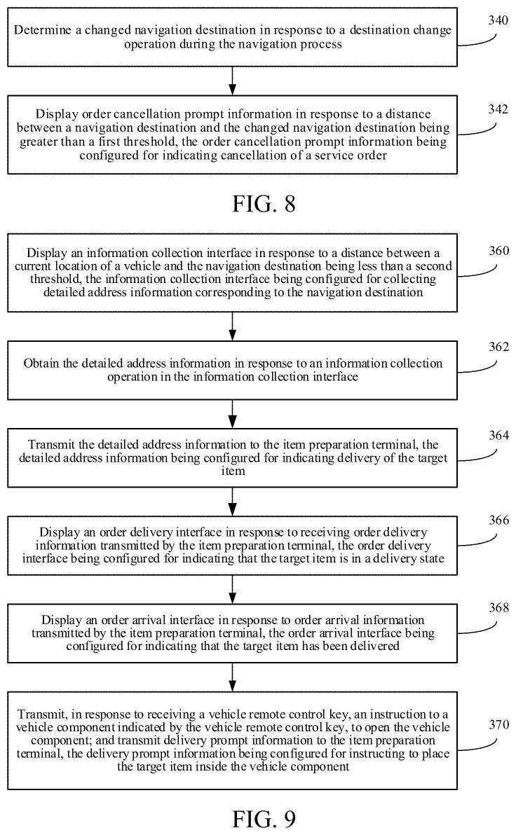

FIG. 8 is a flowchart of an order information processing method according to some embodiments.

In some embodiments, assuming that the user has placed a service order before navigation or during the navigation process, but the user changes the navigation destination during the navigation process, the computer device may issue a prompt.

Specifically, after operation 240 and before operation 260, or after operation 260, in some embodiments, the method further includes operation 340 and operation 342.

Operation 340: Determine a changed navigation destination in response to a destination change operation during the navigation process.

The destination change operation refers to an operation of changing the navigation destination.

In some embodiments, the destination change operation includes at least one of manually inputting the changed navigation destination, inputting the changed navigation destination via voice, or inputting the changed navigation destination by using an intelligent assistant of the terminal.

Operation 342: Display order cancellation prompt information in response to a distance between the navigation destination and the changed navigation destination being greater than a first threshold, the order cancellation prompt information being configured for indicating cancellation of the service order.

The first threshold is a preset distance threshold.

In some embodiments, the first threshold is set by each merchant based on their own delivery capability. Different merchants may set different first thresholds.

For example, while displaying the order cancellation prompt information, the computer device also transmits preparation cancellation prompt information to the merchant terminal, to prompt the merchant to cancel the preparation of the service product.

In some embodiments, if the service order is a customized service order, or the service product in the service order has been prepared, cancellation of the service order is not supported. The computer device may display order exception prompt information in response to the distance between the navigation destination and the changed navigation destination being greater than the first threshold. The order exception prompt information is configured for indicating that the service order cannot be canceled or the item has been prepared, for example, an exception exists in the order, and is configured for prompting the user to contact the merchant to arrange delivery on another day or agree on another processing manner.

In some embodiments, when the navigation destination is changed, a distance difference is determined in real time, and the user is prompted to cancel the service order. This improves the capability of the navigation software in effectively processing orders, thereby helping reduce losses for the user and improving user experience. In addition, the merchant does not may prepare the service product, which can improve efficiency of order scheduling from the perspective of the entire system.

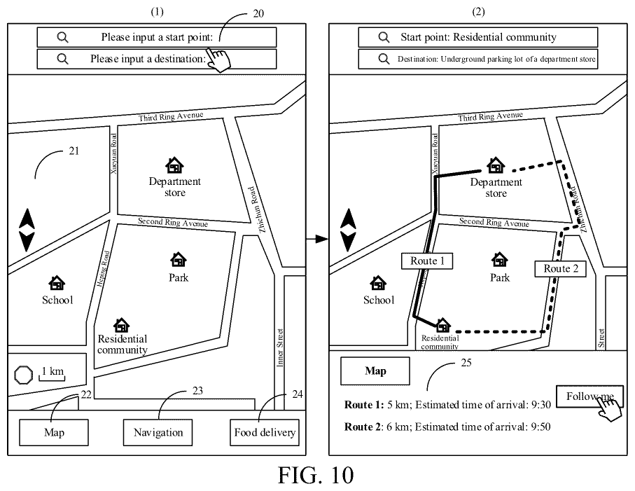

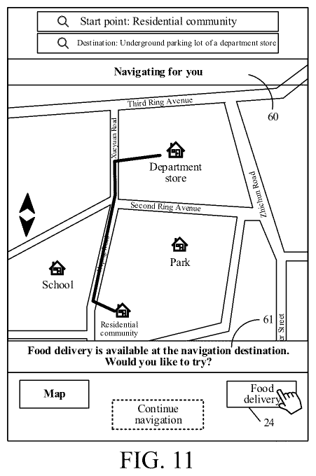

FIG. 9 is a flowchart of an order information processing method according to some embodiments.

In some embodiments, when the user is about to arrive at the navigation destination by driving the vehicle, the user may transmit some address information of the navigation destination to the merchant, to facilitate the delivery of for the service order by the merchant. In some embodiments, after operation 260, the method further includes operation 360, operation 362, and operation 364.

Operation 360: Display an information collection interface in response to a distance between a current location of the vehicle and the navigation destination being less than a second threshold, the information collection interface being configured for collecting detailed address information corresponding to the navigation destination.

The second threshold is a preset distance threshold between the current location of the vehicle and the navigation destination. The second threshold may be set to a smaller value, for example, 100 m.

The information collection interface refers to an interface configured for collecting detailed address information corresponding to the navigation destination, and the detailed address information is configured for guiding the merchant in delivering the service order.

In some embodiments, a fine granularity corresponding to the detailed address information is higher than a fine granularity corresponding to the navigation destination. For example, if the navigation destination is an underground parking lot of a department store, the detailed address information may refer to a level of the underground parking lot of the department store, a parking space, a parking space number for locating the parking space, a key positioning point (an elevator lobby or an advertising board), and the like.

In some embodiments, the detailed address information includes at least one of a video recording, an image, or a parking space number.

The detailed address information may be collected through an in-vehicle sensor or an in-vehicle camera in the vehicle.

The information collection interface can obtain at least one of a video recording captured by a video recording device from the entry of the vehicle into the parking lot until the vehicle arrives at the parking space, an image captured by a surround-view camera of the vehicle (also referred to as a surround-view image or a surround-view visual), an image captured by a fisheye camera of the vehicle, a parking space number directly inputted by the user (manually or via voice) or recognized through the surround-view camera and the fisheye camera by using optical character recognition (OCR), or a global navigation satellite system (GNSS) signal collected by the in-vehicle sensor.

At least one of a indoor location of the vehicle, a level of the parking lot, a parking area number on a parking lot pillar, or a key positioning point (an elevator lobby or an advertising board) can be determined through the foregoing video recording and image. The vehicle can be accurately positioned outdoors through the foregoing GNSS signal.

In some embodiments, the computer device displays the information collection interface when determining that the vehicle has parked. Specifically, the computer device obtains parking information in response to the distance between the current location of the vehicle and the navigation destination being less than the second threshold; and displays the information collection interface in response to the parking information satisfying a parking confirmation condition, the parking confirmation condition including at least one of the vehicle being turned off, the vehicle being locked, the vehicle being currently in park gear (P gear), the vehicle being powered off, or the vehicle being located in a parking space.

Whether the vehicle is located in the parking space may be determined based on the image combined with a parking space detection model. For example, the computer device is installed with and runs a trained parking space detection model. The foregoing image is inputted into the parking space detection model to detect parking space feature points, and whether the vehicle is located in the parking space is determined based on a parking space feature detection result.

Operation 362: Obtain the detailed address information in response to an information collection operation in the information collection interface.

The information collection operation refers to an operation in which the user authorizes or confirms the input of the foregoing route, image, and parking space number into the information collection interface.

In some embodiments, the detailed address information includes at least one of the video recording, the image, or the parking space number.

Operation 364: Transmit the detailed address information to the item preparation terminal, the detailed address information being configured for indicating delivery of the target item.

In this operation, the detailed address information is transmitted to the merchant terminal, the detailed address information being configured for instructing the merchant corresponding to the merchant terminal to deliver the service product in the service order.

For example, the merchant may determine a location of the vehicle based on the detailed address information, to transmit the service product in the service order to the vehicle of the user.

In some embodiments, information related to positioning of the vehicle can be obtained, to facilitate the merchant to obtain the location of the vehicle, thereby helping guide the delivery of the service order and improve efficiency of service order delivery.

Still referring to FIG. 9, in some embodiments, after operation 260, or after operation 364, in some embodiments, the method further includes operation 366 and operation 368.

Operation 366: Display an order delivery interface in response to receiving order delivery information transmitted by the item preparation terminal, the order delivery interface being configured for indicating that the target item is in a delivery state.

In this operation, the order delivery interface is displayed in response to the order delivery information transmitted by the merchant terminal being received, the order delivery interface being configured for indicating that the service product in the service order is in the delivery state.

The order delivery information is information transmitted by the merchant terminal indicating that the service product in the service order is in the delivery state.

Operation 368: Display an order arrival interface in response to order arrival information transmitted by the item preparation terminal, the order arrival interface being configured for indicating that the target item has been delivered.

In this operation, the order arrival interface is displayed in response to the order arrival information transmitted by the merchant terminal, the order arrival interface being configured for indicating that the service order is in a delivered state.

The order arrival information is information transmitted by the merchant terminal or transmitted by a user terminal owned by a delivery person indicating that the service product in the service order is in the delivered state (also referred to as a completed state or a finished state).

In some embodiments, when the service order is delivered to the vehicle but the user is not in the vehicle, the user may also remotely control the vehicle. After operation 368, in some embodiments, the method further includes operation 370.

Operation 370: Transmit, in response to receiving a vehicle remote control key, an instruction to a vehicle component indicated by the vehicle remote control key, to open the vehicle component; and transmit delivery prompt information to the item preparation terminal, the delivery prompt information being configured for instructing to place the target item inside the vehicle component.

In this operation, the vehicle component indicated by the vehicle remote control key is opened, and the delivery prompt information is transmitted to the merchant terminal, the delivery prompt information being configured for instructing to place the service product in the service order inside the vehicle component.

The vehicle remote control key is a digital key configured for remotely controlling the vehicle.

The vehicle component includes at least one of a vehicle door, a vehicle trunk, and a vehicle front trunk.

In some embodiments, when the vehicle does not support remote control, the computer device transmits the delivery prompt information to the merchant terminal, the delivery prompt information being configured for instructing to place the service product in the service order around the vehicle, or the delivery prompt information being configured for instructing to place the service product in the service order inside a lockbox. The lockbox may be connected to a wheel of the vehicle through a digital or electronic lock, allowing the user to retrieve the service product after returning to the vehicle.

In the foregoing embodiment, a delivery process of the service order may be displayed, allowing the delivery person to directly deliver the service product to the vehicle, which can reduce physical effort required by the user to receive the service product, thereby improving user experience.

To describe the order information processing method provided in the embodiments of this application more clearly, the following describes the method with reference to application scenarios and schematic diagrams of the user interface. In the following embodiments, descriptions are provided by using an example in which a service type is a food delivery service, a service order is a food delivery order, and a service product is a food delivery product.

### Example of Application Scenario

An example in which the method is applied to an in-vehicle scenario is used. The vehicle is installed with an in-vehicle terminal, the in-vehicle terminal is installed with and runs a target application, and the target application can provide a navigation service and a food delivery service. For example:

Before driving to an underground parking lot of a navigation destination, or during a process of driving to an underground parking lot of a navigation destination, a user A places an order for a milk tea at a merchant B located at the navigation destination, and places an order for a box of mineral water at a merchant C near the navigation destination through the target application installed and run on the in-vehicle terminal.

Then, the user A continues to drive to the navigation destination through navigation. The merchant B starts preparing the milk tea at a moment TI satisfying the order trigger condition based on estimated time of arrival of the user A, a preparation duration of the milk tea, and a delivery duration from the merchant B to a parking location of the user A at the navigation destination.

Similarly, the merchant C also uses the same manner to prepare the mineral water at a moment T2 when the order trigger condition is satisfied.

After the user A arrives at the navigation destination and during a parking process, at least one of an image, a video, a parking space number, or a GNSS signal near the parking location is transmitted to the merchant B and the merchant C through an in-vehicle camera.

The merchant B may deliver the prepared milk tea to the parking location of the user A through indoor map navigation, and provide the user A with guidance from the parking space to an elevator when necessary.

The merchant C may also deliver the mineral water to the parking location of the user A through indoor map navigation. If the user A is not in the vehicle during delivery, the vehicle may be remotely controlled by the user A to open a vehicle door, a front trunk, or a rear trunk to place the food delivery product inside the vehicle.

### Example of Interface Diagram

The user starts the target application in the in-vehicle terminal. As shown in the schematic diagram (1) in FIG. 10, the in-vehicle terminal displays the navigation interface. The navigation interface includes a navigation information input area 20, a map 21, a map button 22, a navigation button 23, and a food delivery button 24.

The user may select or input a navigation start point and a navigation destination in the navigation information input area 20. The navigation start point is “Residential community”, and the navigation destination is “Underground parking lot of a department store”.

The user may view the map 21 by tapping the map button 22, including viewing a map of a current location, a route map from the navigation start point to the navigation destination, and a map of a location of the navigation destination.

The user may initiate navigation from the navigation start point “Residential community” to the navigation destination “Underground parking lot of a department store” by tapping the navigation button 23.

Before navigation is initiated or during the navigation process, a food delivery ordering area may be displayed by tapping the food delivery button 24, and an order for the food delivery product is placed in the food delivery ordering area. A food delivery address is the navigation destination.

After the user inputs the navigation start point “Residential community” and the navigation destination “Underground parking lot of a department store”, as shown in the schematic diagram (2) in FIG. 10, at least one navigation route is displayed in a route display area 25 on the navigation interface.

In this example, a navigation route 1 and a navigation route 2 are displayed, when the navigation route 1 is 5 km, estimated time of arrival is 9:30, and when the navigation route 2 is 6 km, estimated time of arrival is 9:50. The user may select the navigation route 1, and tap a “Follow me” button to initiate navigation.

During the navigation process, the in-vehicle terminal may display food delivery prompt information on the navigation interface, to inform the user that food delivery is available at the navigation destination.

FIG. 11 is a schematic diagram of a navigation process. The navigation interface displays navigation prompt information 60: “Navigating for you”, to indicate that navigation is in progress. In this case, the in-vehicle terminal may display food delivery prompt information 61 “Food delivery is available at the navigation destination. Would you like to try?” on the navigation interface, to prompt the user to use a food delivery service function. The user may tap the food delivery button 24 to place an order for food delivery.

Regardless of placing an order for food delivery before the navigation or during the navigation process, after the user taps the food delivery button 24, the in-vehicle terminal displays the food delivery ordering area on the navigation interface. In some embodiments, two food delivery order placement manners are set:

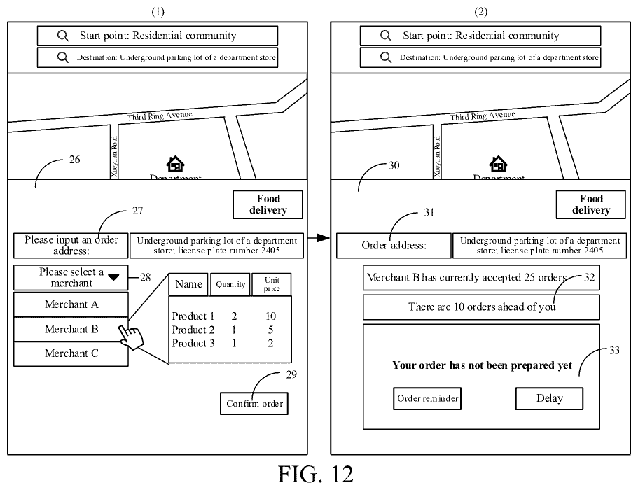

Manner 1: As shown in the schematic diagram (1) in FIG. 12, the in-vehicle terminal displays a food delivery ordering area 26 on the navigation interface, the food delivery ordering area 26 includes an input area 27 of a food delivery address, and the in-vehicle terminal may automatically use the navigation destination as the food delivery address, and add a license plate number 2405 to the food delivery address, to facilitate the merchant to deliver food delivery product to the vehicle.

The food delivery ordering area 26 also display a plurality of candidate merchants 28 located around the navigation destination, including a merchant A, a merchant B, and a merchant C for the user to select. After selecting the merchant B, the user selects a food delivery product from a product 1, a product 2, and a product 3 provided by the merchant B, and places an order through an order confirmation button 29 after the food delivery product is selected.

As shown in the schematic diagram (2) in FIG. 12, after the order is placed, the in-vehicle terminal further displays order information in a food delivery ordering arca 30, the order information including a food delivery address (order address) 31, merchant information 32: merchant order acceptance information: “Merchant B has currently accepted 25 orders” and merchant queue information “There are 10 orders ahead of you”, and order not yet prepared prompt information 33: “Your order has not started being prepared yet”.

In some embodiments, an order remind button and a delay button are further included below the order not yet prepared prompt information 33. The user may tap the order remind button to remind the merchant to start preparing the food delivery product earlier, and tap the delay button to notify the merchant to postpone the preparation of the food delivery product.

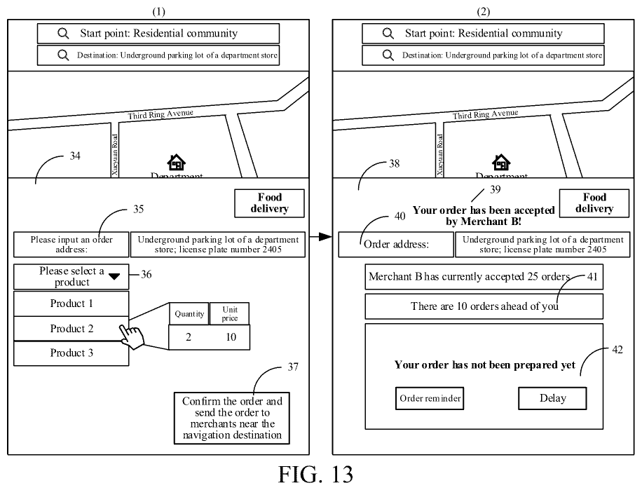

Manner 2: As shown in the schematic diagram (1) in FIG. 13, the in-vehicle terminal displays a food delivery ordering area 34 on the navigation interface, the food delivery ordering area 34 includes an input area 35 of a food delivery address, and the in-vehicle terminal may automatically use the navigation destination as the food delivery address, and add a license plate number 2405 to the food delivery address, to facilitate the merchant to deliver food delivery product to the vehicle.

The food delivery ordering area 35 also displays a plurality of candidate products 36, including a product 1, a product 2, and a product 3, for the user to select. After selecting the product 2, the user confirms an order through an order confirmation button 37, and the in-vehicle terminal transmits the order to a plurality of candidate merchants around the navigation destination.

As shown in the schematic diagram (2) in FIG. 13, after the order is placed, the in-vehicle terminal further displays order acceptance information 39 and order information in a food delivery ordering area 38, the order acceptance information 39 “Your order has been accepted by Merchant B” being configured for indicating that the food delivery order has been accepted by the merchant B, and the order information including a food delivery address (order address) 40, merchant information 41: merchant order acceptance information: “Merchant B has currently accepted 25 orders” and merchant queue information: “There are 10 orders ahead of you”, and order not yet prepared prompt information 42: “Your order has not started being prepared yet”.

In some embodiments, an order remind button and a delay button are further included below the order not yet prepared prompt information 42. The user may tap the order remind button to remind the merchant to start preparing the food delivery product earlier, and tap the delay button to notify the merchant to postpone the preparation of the food delivery product.

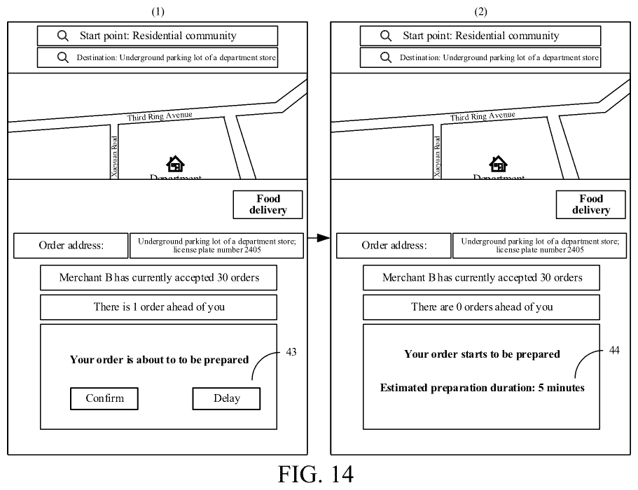

After the user successfully places the order, the in-vehicle terminal determines, based on a preset interval, whether the order trigger condition is satisfied. As shown in the schematic diagram (1) in FIG. 14, when the order trigger condition is satisfied, the in-vehicle terminal first displays a second order state, for example, order preparation pre-prompt information 43 “Your order is about to be prepared”, to indicate that the food delivery product is about to enter the preparation state.

In some embodiments, a confirmation button and a delay button are further included below the order preparation pre-prompt information 43. The user may tap the confirmation button for a secondary confirmation of the preparation of the food delivery product, and tap the delay button to notify the merchant to postpone the preparation of the food delivery product.

When the user does not tap the confirmation button or the delay button within a preset duration (for example, 2 s), the preparation is confirmed by default. As shown in the schematic diagram (2) in FIG. 14, item preparation prompt information 44 “Your order starts to be prepared. Estimated preparation duration: 5 minutes” is displayed, to indicate that the food delivery product is in the preparation state.

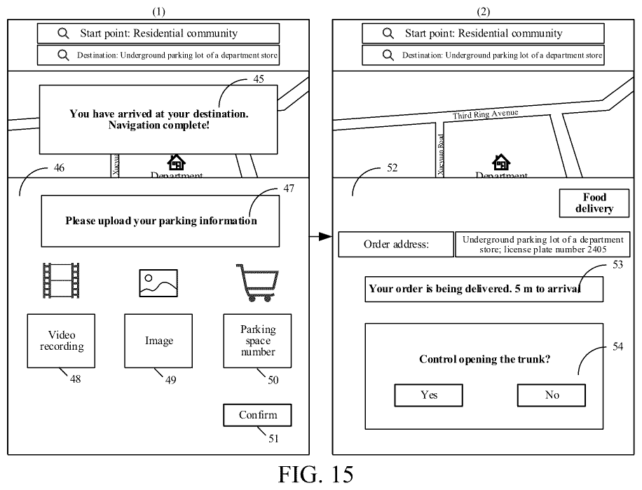

After the user arrives at the navigation destination, as shown in the schematic diagram (1) in FIG. 15, the in-vehicle terminal displays, on the navigation interface, navigation end prompt information 45 “You have arrived at your destination. Navigation has ended!”, to indicate that the user has arrived at the navigation destination. The in-vehicle terminal displays an information collection interface 46, configured for collecting detailed address information corresponding to the navigation destination. The information collection interface 46 includes information collection prompt information 47 “Please upload your parking information”, and supports uploading a video recording 48, an image 49, and a parking space number 50.

After uploading, the user taps a confirmation button 51, and the in-vehicle terminal may transmit the detailed address information to the merchant terminal, the detailed address information being configured for instructing the merchant corresponding to the merchant terminal to deliver the food delivery order.

As shown in the schematic diagram (2) in FIG. 15, the in-vehicle terminal displays an order delivery interface 52, and the order delivery interface 52 displays delivery prompt information 53 “Your order is being delivered, 5 meters away”, to indicate that the food delivery order is in a delivery state.

In some embodiments, the in-vehicle terminal also displays remote control prompt information 54 “Would you like to open the trunk?”, to facilitate the delivery person to place the food delivery product in the food delivery order inside the trunk of the vehicle.

In some embodiments, the in-vehicle terminal may also provide an indoor guidance route. It is assumed that the user may go from a parking space located on level B3 of a department store to a shop X on level L1 of the department store.

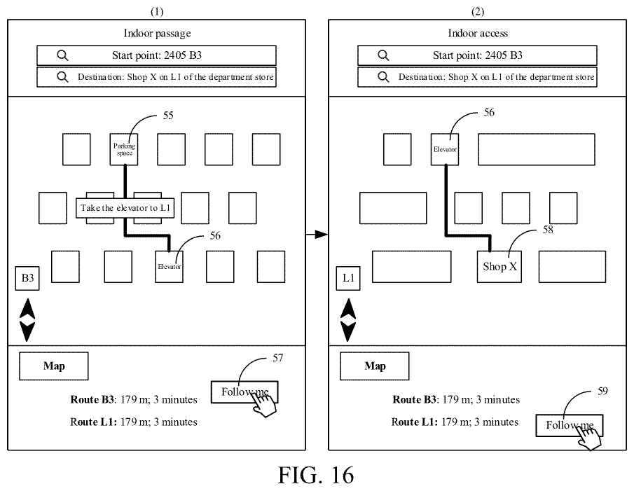

The in-vehicle terminal also displays a route B3 and a route L1. As shown in the schematic diagram (1) in FIG. 16, the route B3 is a route from a parking space 55 to an elevator 56, measuring 179 m and taking 3 minutes. The user taps a “Follow me” button 57 to navigate the route. As shown in the schematic diagram (2) in FIG. 16, the route L1 is a route from the elevator 56 to a shop X58, measuring 179 m and taking 3 minutes. The user taps a “Follow me” button 59 to navigate the route. Therefore, the user may arrive at the shop X from the parking space based on the foregoing indoor guidance route.

### Example of Backend Implementation

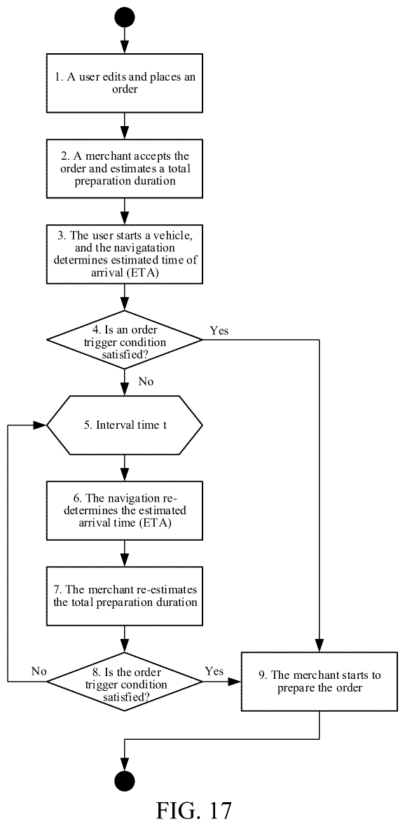

FIG. 17 is a flowchart of an order information processing method according to some embodiments. The method mainly includes the following operations.

1. A user edits and places an order.

The user places an order with a food delivery address being a vehicle at a navigation destination.

An order placement procedure may occur before navigation or after navigation.

If the order is placed before navigation, an in-vehicle terminal may recommend the user to initiate navigation to the navigation destination. If the order is placed after navigation, the in-vehicle terminal may recommend merchants around the navigation destination to the user after navigation.

The user may edit a type and a quantity of food delivery products and customize information for a food delivery order. The user confirms the order, and the in-vehicle terminal transmits configuration information edited by the user to a merchant.

2. A merchant accepts the order and estimates a preparation duration corresponding to the food delivery order.

A preparation duration p is determined after the merchant accepts the order. The preparation duration may be vary based on order information customized by the user or a current workload of the merchant, and is a time-dependent estimate that changes dynamically.

3. The user starts a vehicle, and the navigation determines estimated time of arrival (ETA) for arriving at the navigation destination.

The in-vehicle terminal determines the estimated time of arrival for arriving at the navigation destination based on a navigation path selected by the user, current weather and traffic conditions, and a driving style obtained by analyzing driving history information of the user. A real-time remaining duration e of the route is calculated based on the estimated time of arrival.

4. Determine whether an order trigger condition is satisfied; and if the order trigger condition is satisfied, perform operation 9, or if the order trigger condition is not satisfied, perform operation 5.

In some embodiments, the order trigger condition is set as follows: e≤p+s+r.

e is the real-time remaining duration after the vehicle arrives at the navigation destination, p is a preparation duration of the food delivery product, r is a delivery duration of the food delivery product, and s is a preset buffer duration.

s is set by the user, for example, the user has a planned or unexpected arrangement during driving that may consume time. s may also be configured for controlling a case in which p and r are excessively small in an estimation.

r may originate from an outdoor or indoor navigation map, or may be from statistical analysis of historical data, or may be set independently by the merchant.

5. Periodically check the order trigger condition based on an interval time t.

At every interval time t, perform operation 6. The navigation re-determines the estimated time of arrival (ETA), perform operation 7. The merchant re-estimates a total preparation duration of the food delivery product, and perform operation 8. Determine whether the order trigger condition is satisfied; and if the order trigger condition is satisfied, perform operation 9, or if the order trigger condition is not satisfied, perform operation 5.

In some embodiments, it is undesirable for the user to wait for the order to be completed after arrival (which is applicable to a case of queueing with a number), it is also undesirable for the user to receive the order (for example, a milk tea or another food delivery) long after the order is prepared, and it is also undesirable for the user to have to constantly pay attention to a queue status and manually place an order during driving, which may affect driving safety. Therefore, a value of t is set to be as small as possible, so that the trigger can be activated immediately when the order trigger condition is satisfied. It is also possible to periodically check the order trigger condition based on a driving mileage (checking after driving a distance) or based on an order queue status of the merchant (actively triggering when a new order arrives).

9. The merchant starts to prepare the order.

After starting to prepare the order, the merchant may notify the user.

In addition, a confirmation option may also be provided for the user, so that preparation starts only after confirmation of the user is received, to avoid problems caused by changes in the user's schedule or an unexpected new plan.

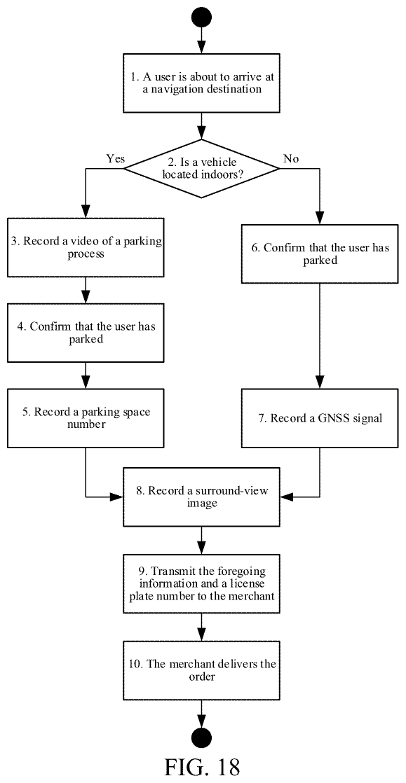

FIG. 18 is a flowchart of an order information processing method according to some embodiments. After a user arrives at a navigation destination, the method mainly includes the following operations.

1. The user has arrived at or is about to arrive at a navigation destination.

2. Determine whether a vehicle is located indoors; and if the vehicle is located indoors, perform operations 3-5, or if the vehicle is not located indoors (is located outdoors), perform operations 6-7.

If the vehicle is parked indoors and cannot obtain a GNSS signal, perform operation 3. Obtain a video recording recorded after entering the underground where the GNSS signal is lost.

The video recording may record the entire process from entering a parking lot to arriving at a parking location, and a merchant familiar with the layout of the underground parking lot can determine an approximate location of the vehicle based on the video recording.

In addition, the video recording can also record a parking level of the vehicle, a parking area number on a pillar, and a key positioning feature point such as an elevator lobby or an advertising board. Even if the merchant is not familiar with the parking lot, the merchant can also location the vehicle of the user on such a basis.

4. Confirm that the user has parked.

A determining condition for determining that the user has parked includes at least one of the vehicle being turned off, the vehicle being locked, the vehicle being in P gear, the vehicle being powered off, or the vehicle being located in a parking space (which can be determined through a surround-view visual combined with a parking space detection model).

5. Record a parking space number.

The parking space number may be obtained through any one of the following manners: OCR recognition during a reversing process of the vehicle, OCR recognition after the user takes a photo of the parking space through a mobile phone, manual input by the user, or association with the parking space after a license plate is captured and recognized by a camera in the parking lot.

If the vehicle is parked outdoors, perform operation 6. Confirm that the user has parked. 7. Record a GNSS signal.

An absolute position of the vehicle is obtained through the GNSS signal. In this case, a video, a parking space number, or the like is not needed.

8. Record a surround-view image. The surround-view image of the vehicle that is captured through a surround-view camera of the vehicle can help the merchant familiar with the environment to quickly locate the vehicle.

9. Transmit the foregoing information and the license plate number to the merchant.

10. The merchant delivers an order based on the foregoing information and the license plate number.

In some embodiments, positioning may also be assisted based on a Bluetooth beacon or based on a simultaneous localization and mapping (SLAM) technology. For example, feature points are extracted from a single image or a set of images captured, and compared with data of feature points in a database. Then, positioning information is provided in a manner such as multi-view geometry.

When the order is delivered but the user is not in the vehicle, the following several order delivery manners may be set.

1. When delivering an item to the vehicle of the user, the merchant can use a user-authorized digital key or contact the user to remotely unlock the vehicle or a part of the vehicle, such as a front trunk, a rear trunk, or a front passenger door of the vehicle through an APP of the vehicle.

Then, the merchant may place the item in a specified position, lock the vehicle, and leave. This process is equivalent to using the vehicle as a delivery locker. In addition, video recording may be performed through a driver monitor system (DMS) camera inside the vehicle and through the surround-view camera outside the vehicle, to facilitate the user to view the delivery process.

2. The merchant may place the item near a vehicle supporting video recording by the surround-view camera, for example, a Sentry mode. The user may view the item through an in-vehicle camera, and the user may be notified in time when a position of the item changes.

3. The merchant may store the item into a locked box, and position the box near the vehicle of the user.

The box may be connected to a vehicle wheel through a digital or electronic lock. After the user returns to the vehicle and retrieves the item by entering a password or in another authorization manner, the merchant is notified to collect the locked storage box.

In conclusion, according to the order information processing method provided in the embodiments of this application, an example in which a service type is a food delivery service is used. a navigation service can be combined with a food delivery service, which can improve efficiency of order scheduling, enrich service content of the navigation service, help the user to reduce the duration required to complete the entire process of the order and physical effort required to receive the food delivery product, and improve service quality of the food delivery service.

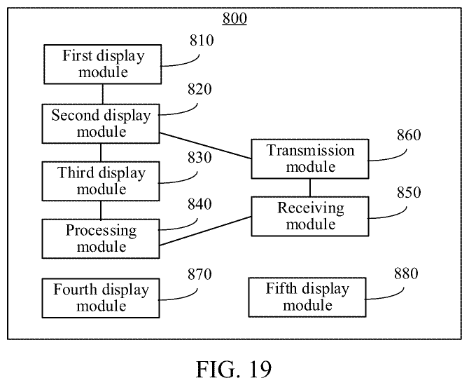

FIG. 19 is a block diagram of an order information processing apparatus 800 according to some embodiments. The order information processing apparatus 800 includes:

a first display module 810, configured to display a navigation interface in response to a navigation operation of a vehicle, the navigation interface including an order control, the order control being configured to generate an order related to a target item;

a second display module 820, configured to generate and display order information of the order in response to an operation of a user on the order control, the order information including a navigation destination inputted during the navigation operation; and

a third display module 830, configured to generate and display a first order state in response to a first duration being less than or equal to a second duration, the first order state being configured for indicating that the target item is in a preparation state, the first duration being determined based on a real-time remaining duration for the vehicle to arrive at the navigation destination, and the second duration being determined based on a real-time delivery duration of the target item.

In some embodiments, the third display module 830 is configured to: transmit order activation information to an item preparation terminal in response to the first duration being less than or equal to the second duration, the order activation information being configured for indicating that the order received by the item preparation terminal is valid; receive item preparation confirmation information returned by the item preparation terminal; and generate and display the first order state in response to the item preparation confirmation information.

In some embodiments, the apparatus further includes a processing module 840.

The processing module 840 is configured to obtain the first duration and the second duration based on a preset interval,

the preset interval being determined based on at least one of the following:

a preset time interval

a preset driving mileage interval; or

order queue information generated by the item preparation terminal.

In some embodiments, the apparatus further includes a receiving module 850.

The receiving module 850 is configured to receive order queue information transmitted by the item preparation terminal.

The processing module 840 is configured to: determine, in response to the order queue information, whether the item preparation terminal receives a new order after receiving the order; and trigger obtaining of the first duration and the second duration when determining that the item preparation terminal receives the new order.

In some embodiments, the display module 820 is configured to: display an order generation sub-area on the navigation interface in response to the operation of the user on the order control; and generate configuration information of the order in response to a configuration operation of the user in the order generation sub-area.

The apparatus further includes a transmission module 860, configured to transmit the configuration information to the item preparation terminal in response to a confirmation operation of the user on the configuration information.

The receiving module 850 is configured to receive order confirmation information returned by the item preparation terminal.

The display module 820 is configured to generate and display the order information in response to the order confirmation information.

In some embodiments, the display module 820 is configured to: display, on the navigation interface in response to the configuration operation, information about a plurality of candidate item preparation terminals located around the navigation destination; determine the item preparation terminal in response to a selection operation of the user on the plurality of candidate item preparation terminals, and display information about a plurality of candidate items provided by the item preparation terminal; determine the target item in response to a selection operation of the user on the plurality of candidate items; and generate the configuration information based on the item preparation terminal and the target item.

In some embodiments, the display module 820 is configured to: display information about a plurality of candidate items in response to the configuration operation; determine the target item in response to a selection operation of the user on the plurality of candidate items; and generate the configuration information based on the target item.

The transmission module 860 is configured to: transmit, in response to the confirmation operation, the configuration information to at least one candidate item preparation terminal located around the navigation destination, a candidate item preparation terminal matching a type of the target item being determined as the item preparation terminal; or among a plurality of candidate item preparation terminals, a candidate item preparation terminal that first returns the order confirmation information being determined as the item preparation terminal.

In some embodiments, the transmission module 860 is further configured to transmit secondary confirmation information to the item preparation terminal in response to a confirmation operation on the first order state, the secondary confirmation information being configured for indicating that the user has reconfirmed the preparation of the target item.

In some embodiments, the apparatus further includes a display module 870.

The display module 870 is further configured to: determine a changed navigation destination in response to a destination change operation during a navigation process; and display order cancellation prompt information in response to a distance between the navigation destination and the changed navigation destination being greater than a first threshold, the order cancellation prompt information being configured for indicating cancellation of the order.

In some embodiments, the display module 870 is further configured to: display an information collection interface in response to a distance between a current location of the vehicle and the navigation destination being less than a second threshold, the information collection interface being configured for collecting detailed address information corresponding to the navigation destination; and obtain the detailed address information in response to an information collection operation in the information collection interface.

The transmission module 860 is further configured to transmit the detailed address information to the item preparation terminal, the detailed address information being configured for indicating delivery of the target item.

In some embodiments, the display module 870 is configured to: obtain parking information in response to the distance between the current location of the vehicle and the navigation destination being less than the second threshold; and display the information collection interface in response to the parking information satisfying a parking confirmation condition, the parking confirmation condition including at least one of the vehicle being turned off, the vehicle being locked, the vehicle being currently in park gear, the vehicle being powered off, or the vehicle being located in a parking space.

In some embodiments, the apparatus further includes a display module 880, configured to: display an order delivery interface in response to receiving order delivery information transmitted by the item preparation terminal, the order delivery interface being configured for indicating that the target item is in a delivery state; and display an order arrival interface in response to order arrival information transmitted by the item preparation terminal, the order arrival interface being configured for indicating that the target item has been delivered.

In some embodiments, the transmission module 860 is further configured to: in response to a vehicle remote control key, transmit an instruction to a vehicle component indicated by the vehicle remote control key, to open the vehicle component; and transmit delivery prompt information to the item preparation terminal, the delivery prompt information being configured for instructing to place the target item inside the vehicle component.

For limitations in the foregoing embodiments of at least one provided an order information processing apparatus, refer to the foregoing limitations for the order information processing method. Details are not described herein again. The modules of the foregoing apparatus may be all or partially implemented by software, hardware, and a combination thereof. The modules may be embedded in or independent of a processor of a computer device in a hardware form, or may be stored in a memory of the computer device in a software, to be called by the processor to perform the operations corresponding to the modules.

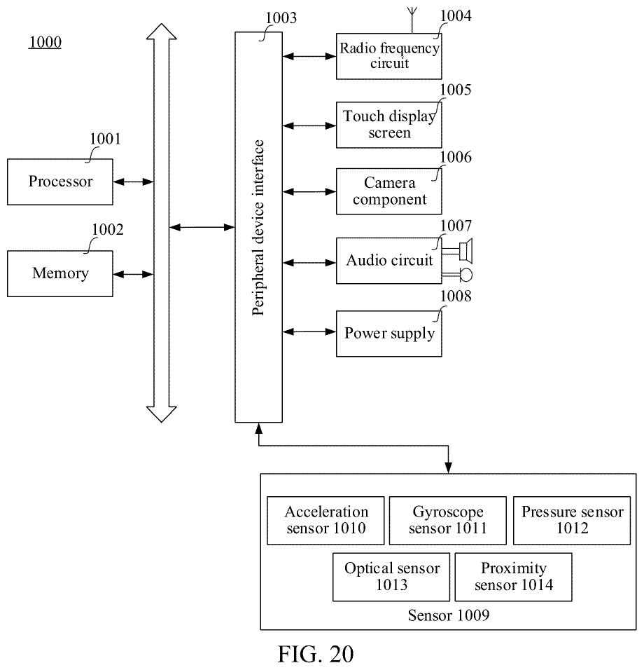

FIG. 20 is a structural block diagram of a computer device according to some embodiments.

A computer device 1000 may be a portable mobile terminal or an in-vehicle terminal (in-vehicle infotainment system), such as a smartphone, a tablet computer, a moving picture experts group audio layer III (MP3) player, a moving picture experts group audio layer IV (MP4) player, an in-vehicle infotainment system, a driving recorder, or a vehicle control device. The computer device 1000 may be referred to as a user device, a portable terminal, or another similar name.

Generally, the computer device 1000 includes a processor 1001 and a memory 1002.

The processor 1001 may include at least one processing cores, such as a 4-core processor and an 8-core processor. The processor 1001 may be implemented in at least one hardware form of a digital signal processor (DSP), a field programmable gate array (FPGA), and a programmable logic array (PLA). The processor 1001 may also include a main processor and a co-processor. The main processor is a processor configured to process data in an awake state, and is also referred to as a central processing unit (CPU). The co-processor is a low power consumption processor configured to process the data in a standby state. In some embodiments, the processor 1001 may be integrated with a graphics processing unit (GPU). The GPU is configured to render and draw content that may be displayed on a display screen. In some embodiments, the processor 1001 may further include an artificial intelligence (AI) processor. The AI processor is configured to process a computing operation related to machine learning.

The memory 1002 may include at least one computer-readable storage medium. The computer-readable storage medium may be tangible and non-transient. The memory 1002 may also include a high-speed random access memory, a nonvolatile memory, such as at least one disk storage device and flash storage device. In some embodiments, a non-transitory computer-readable storage medium in the memory 1002 is configured to store at least one instructions, and the at least one instructions are configured to be executed by the processor 1001, to implement the order information processing method provided in the embodiments of this application.

In some embodiments, the computer device 1000 may further include a peripheral interface 1003 and at least one peripheral device. Specifically, the peripheral device includes at least one of a radio frequency circuit 1004, a touch display screen 1005, a camera component 1006, an audio circuit 1007, and a power supply 1008.

The peripheral device interface 1003 may be configured to connect at least one peripheral device related to input/output (I/O) to the processor 1001 and the memory 1002. In some embodiments, the processor 1001, the memory 1002, and the peripheral device interface 1003 are integrated on a same chip or a circuit board. In some other embodiments, any one or two of the processor 1001, the memory 1002, and the peripheral device interface 1003 may be implemented on a single chip or the circuit board. This is not limited in some embodiments.

The radio frequency circuit 1004 is configured to receive and transmit a radio frequency (RF) signal, which is also referred to as an electromagnetic signal. The radio frequency circuit 1004 communicates with a communication network and another communication device through the electromagnetic signal. The radio frequency circuit 1004 converts an electrical signal into the electromagnetic signal for transmission, or converts a received electromagnetic signal into the electrical signal. In some embodiments, the radio frequency circuit 1004 includes an antenna system, an RF transceiver, at least one amplifier, a tuner, an oscillator, a digital signal processor, an encoding and decoding chip set, a subscriber identity module card, and the like. The radio frequency circuit 1004 may communicate with another terminal through at least one wireless communication protocol. The wireless communication protocol includes, but is not limited to, the world wide web, a metropolitan area network, an intranet, various mobile communication networks (2G, 3G, 4G, and 5G), a wireless local area network, and/or a wireless fidelity (Wi-Fi) network. In some embodiments, the radio frequency circuit 1004 may further include a circuit related to near field communication (NFC). This is not limited in this application.

The touch display screen 1005 is configured to display a user interface (UI). The UI may include a graph, a text, an icon, a video, or any combination thereof. The touch display screen 1005 further has a capability of collecting a touch signal on or above the surface of the touch display screen 1005. The touch signal may be inputted into the processor 1001 as a control signal for processing. The touch display screen 1005 is configured to provide a virtual button and/or a virtual keyboard, also referred to as a soft button and/or a soft keyboard. In some embodiments, the touch display screen 1005 may be one touch display screen, and a front panel of the computer device 1000 is disposed. In some other embodiments, there may be at least two touch display screens 1005 that are respectively disposed on different surfaces of the computer device 1000 or in a folded design. In some embodiments, the touch display screen 1005 may be a flexible display screen, and is disposed on a curved surface or a folded surface of the computer device 1000. Even, the touch display screen 1005 may be set to be a non-rectangular irregular figure, for example, a special-shaped screen. The display screen 1005 may be prepared by using a material such as a liquid crystal display (LCD) or an organic light-emitting diode (OLED).

The camera assembly 1006 is configured to capture an image or a video. In some embodiments, the camera assembly 1006 includes a front camera and a rear camera. Generally, the front camera is configured to implement video calls or selfies, and the rear camera is configured to implement photo taking or video recording. In some embodiments, there are at least two rear cameras that are respectively any one of a main camera, a depth of field camera, and a wide-angle camera, to fuse the main camera and the depth of field camera to implement a background blurring function, and fuse the main camera and the wide-angle camera to implement panorama photographing and a virtual reality (VR) photographing function. In some embodiments, the camera assembly 1006 may further include a flash. The flash may be a solid-color temperature flash, or may be a dual-color temperature flash. The dual-color temperature flash refers to a combination of a warm-light flash and a cool-light flash, and may be used for light compensation in different color temperatures.

The audio circuit 1007 is configured to provide an audio interface between the user and the computer device 1000. The audio circuit 1007 may include a microphone and a speaker. The microphone is configured for collecting sound waves of a user and an environment, convert the sound waves into the electric signal, and input the electric signal to the processor 1001 for processing, or input the electric signal to the radio frequency circuit 1004 for implementing voice communication. For the purpose of stercophonic sound collection or denoising, there may be a plurality of microphones, and the microphones are respectively arranged at different parts of the computer device 1000. The microphone may be an array microphone or an omnidirectional microphone. The speaker is configured for converting the electric signal from the processor 1001 or the radio frequency circuit 1004 into an acoustic wave. The speaker may be a thin-film speaker, or may be a piezoelectric ceramic speaker. When the speaker is the piezoelectric ceramic speaker, the speaker not only can convert the electric signal into a sound wave audible to human, but also can convert the electric signal into a sound wave inaudible to human, for the purpose such as ranging. In some embodiments, the audio circuit 1007 may further include a headphone jack.

The power supply 1008 is configured for supplying power to components in the computer device 1000. The power supply 1008 may be an alternating current, a direct current, a disposable battery, or a rechargeable battery. When the power supply 1008 includes the rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may further be configured for supporting a fast charge technology.

In some embodiments, the computer device 1000 further includes at least one sensor 1009. The at least one sensor 1009 includes, but is not limited to, an acceleration sensor 1010, a gyroscope sensor 1011, a pressure sensor 1012, an optical sensor 1013, and a proximity sensor 1014.

The acceleration sensor 1010 may detect magnitude of accelerations on three coordinate axes of a coordinate system established by the computer device 1000. For example, the acceleration sensor 1010 may be configured for detecting components of a gravitational acceleration on the three coordinate axes. The processor 1001 may control, based on a gravity acceleration signal collected by the acceleration sensor 1010, the touch display screen 1005 to display the user interface in a landscape mode or a portrait mode. The acceleration sensor 1010 may further be configured for collecting movement data of a game or a user.

The gyroscope sensor 1011 may detect a body direction and a rotation angle of the computer device 1000. The gyroscope sensor 1011 may cooperate with the acceleration sensor 1010 to collect a three-dimensional (3D) action of the user on the computer device 1000. The processor 1001 may implement the following functions based on data collected by the gyroscope sensor 1011: action sensing (for example, changing the UI based on a tilt operation of a user), image stability during photographing, game control, and inertial navigation.

The pressure sensor 1012 may be arranged on a side frame of the computer device 1000 and/or a lower layer of the touch display screen 1005. When disposed on the side frame of the computer device 1000, the pressure sensor 1012 may detect a holding signal of the user on the computer device 1000, and perform left-right hand recognition or a shortcut operation based on the holding signal. When the pressure sensor 1012 is disposed at the lower layer of the touch display screen 1005, an operable control on the UI interface may be controlled based on a pressure operation of the user on the touch display screen 1005. The operable control includes at least one of a button control, a scroll bar control, an icon control, and a menu control.

The optical sensor 1013 is configured for collecting an ambient light intensity. In some embodiments, the processor 1001 may control display luminance of the touch display screen 1005 based on the ambient light intensity collected by the optical sensor 1013. Specifically, when the ambient light intensity is high, the display luminance of the touch display screen 1005 is increased. When the ambient light intensity is low, the display luminance of the touch display screen 1005 is decreased. In another embodiment, the processor 1001 may further dynamically adjust the photographing parameter of the camera assembly 1006 based on the ambient light intensity collected by the optical sensor 1013.

The proximity sensor 1014, also referred to as a distance sensor, is generally disposed on a front surface of the computer device 1000. The proximity sensor 1014 is configured for collecting a distance between the user and a front face of the computer device 1000. In some embodiments, when the proximity sensor 1014 detects that the distance between the user and the front face of the computer device 1000 gradually becomes smaller, the processor 1001 controls the touch display screen 1005 to switch from a screen-on state to a screen-off state. When the proximity sensor 1014 detects that the distance between the user and the front face of the computer device 1000 gradually increases, the processor 1001 controls the touch display screen 1005 to switch from the screen-off state to the screen-on state.

A person skilled in the art may understand that the structure shown in FIG. 20 does not constitute a limitation on the computer device 1000, and the terminal may include more or fewer components than those shown in the figure, or combine some components, or have different component deployment.

In some embodiments, this application provides a chip. The chip includes a programmable logic circuit and/or program instructions. When run on a computer device, the chip is configured to implement the order information processing method provided in the foregoing method embodiments.

This application provides a computer-readable storage medium. The computer-readable storage medium has a computer program stored therein, the computer program being loaded and executed by a processor to implement the order information processing method provided in the foregoing method embodiments.

This application provides a computer program product or a computer program. The computer program product or the computer program includes computer instructions, the computer instructions being stored in a computer-readable storage medium. A processor of a computer device reads the computer instructions from the computer-readable storage medium, and the processor executes the computer instructions, to be loaded and executed by the processor of the computer device to implement the method for providing order information provided in the foregoing method embodiments.

Sequence numbers of the foregoing embodiments of this application are merely for description, and do not indicate superiority or inferiority of the embodiments.

A person of ordinary skill in the art may understand that all or some of operations of the foregoing embodiments may be implemented by hardware, or may be implemented by a program instructing relevant hardware. The program may be stored in a computer-readable storage medium. The computer-readable storage medium may be a read-only memory, a magnetic disk, an optical disc, or the like.

A person skilled in the art may be aware of that in at least one embodiment, the functions described in the embodiments of this application may be implemented by hardware, software, firmware, or a combination or the above. When implemented by using software, the functions can be stored in a computer-readable medium or can be used as at least one instructions or code in a computer-readable medium for transferring. The computer-readable medium includes a computer storage medium and a communication medium, the communication medium including any medium that enables a computer program to be transmitted from one place to another. The storage medium may be any available medium accessible to a general-purpose or dedicated computer.

The above mentioned descriptions are merely the optional embodiments of this application, but are not intended to limit this application. Any modification, equivalent replacement, or improvement made without departing from the spirit and principle of this application may fall within the protection scope of this application.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A navigation information processing method, performed by a computer device, the method comprising:
displaying a navigation interface based on a navigation operation of a vehicle, the navigation interface comprising an order control configured to generate an order for a target item;
generating and displaying order information based on a user operation on the order control, the order information comprising a navigation destination inputted during the navigation operation; and
determining a first duration based on a real-time remaining travel time for the vehicle to arrive at the navigation destination;
determining a second duration based on a real-time preparation time and delivery time of the target item; and
generating and displaying a preparation state for indicating that the target item is in preparation, based on the first duration being less than or equal to the second duration.

2. The method according to claim 1, wherein the generating and displaying the preparation state comprises:
transmitting order activation information to an item preparation terminal, based on the first duration being less than or equal to the second duration,
wherein the order activation information indicates that the order received by the item preparation terminal is valid;
receiving preparation confirmation information from the item preparation terminal; and
generating and displaying the preparation state in response to the preparation confirmation information.

3. The method according to claim 1, further comprising:
obtaining the first duration and the second duration based on a preset interval,
wherein the preset interval is determined based on at least one of the following:
a preset time interval
a preset driving mileage interval; or
order queue information generated by a item preparation terminal.

4. The method according to claim 1, further comprising:
receiving queue information transmitted from a item preparation terminal;
determining, based on the order queue information, whether the item preparation terminal receives a new order after receiving the order; and
obtaining the first duration and the second duration based on the item preparation terminal receiving the new order.

5. The method according to claim 1, wherein the generating and displaying order information comprises:
displaying an order generation sub-area on the navigation interface based on the user operation on the order control;
generating configuration information of the order based on a user configuration operation in the order generation sub-area;
transmitting the configuration information to an item preparation terminal based on a user confirmation operation on the configuration information;
receiving order confirmation information from the item preparation terminal; and
generating and displaying the order information based on the order confirmation information.

6. The method according to claim 5, wherein the generating configuration information comprises:
displaying, on the navigation interface based on the user configuration operation, information about a plurality of candidate item preparation terminals located around the navigation destination;
determining the item preparation terminal based on a user selection operation on the plurality of candidate item preparation terminals;
displaying information about a plurality of candidate items provided from the item preparation terminal;
determining the target item based on a user selection operation on the plurality of candidate items; and
generating the configuration information based on the item preparation terminal and the target item.

7. The method according to claim 5, wherein the generating configuration information comprises:
displaying information about a plurality of candidate items based on the configuration operation;
determining the target item based on a selection operation of the user on the plurality of candidate items; and
generating the configuration information based on the target item; and
wherein the transmitting the configuration information comprises:
determining at least one candidate item preparation terminal as the item preparation terminal, based on at least one of the following conditions:
the at least one candidate item preparation terminal matches a type of the target item, or
the at least one candidate item preparation terminal is first to return order confirmation data among a plurality of candidate item preparation terminals;
transmitting, based on the user confirmation operation, the configuration information to the at least one candidate item preparation terminal.

8. The method according to claim 1, further comprising:
transmitting secondary confirmation information to the item preparation terminal based on a confirmation operation on the preparation state,
wherein the secondary confirmation information indicates that the user has reconfirmed the preparation of the target item.

9. The method according to claim 1, further comprising:
determining a changed navigation destination based on a destination change operation during navigation; and
displaying order cancellation prompt information based on a distance between the navigation destination and the changed navigation destination being greater than a first threshold.

10. The method according to claim 1, further comprising:
displaying an information collection interface based on a distance between a current location of the vehicle and the navigation destination being less than a second threshold,
wherein the information collection interface collects detailed address information corresponding to the navigation destination;
obtaining the detailed address information based on an information collection operation in the information collection interface; and
transmitting the detailed address information to an item preparation terminal.

11. A navigation information processing apparatus, comprising:
at least one memory configured to store program code; and
at least one processor configured to read the program code and operate as instructed by the program code, the program code comprising:
display code configured to cause at least one of the at least one processor to display a navigation interface based on a navigation operation of a vehicle, the navigation interface comprising an order control configured to generate an order for a target item;
order code configured to cause at least one of the at least one processor to generate and display order information based on a user operation on the order control, the order information comprising a navigation destination inputted during the navigation operation; and
first determination code configured to cause at least one of the at least one processor to determine a first duration based on a real-time remaining travel time for the vehicle to arrive at the navigation destination;
second determination code configured to cause at least one of the at least one processor to determine a second duration based on a real-time preparation time and delivery time of the target item; and
preparation code configured to cause at least one of the at least one processor to generate and display a preparation state for indicating that the target item is in preparation, based on the first duration being less than or equal to the second duration.

12. The apparatus according to claim 11, wherein the preparation code is further configured to cause at least one of the at least one processor to:
transmit order activation information to an item preparation terminal, based on the first duration being less than or equal to the second duration,
wherein the order activation information indicates that the order received by the item preparation terminal is valid;
receive preparation confirmation information from the item preparation terminal; and
generate and display the preparation state in response to the preparation confirmation information.

13. The apparatus according to claim 11, wherein the program code further comprises:
interval code configured to cause at least one of the at least one processor to obtain the first duration and the second duration based on a preset interval,
wherein the preset interval is determined based on at least one of the following:
a preset time interval
a preset driving mileage interval; or
order queue information generated by a item preparation terminal.

14. The apparatus according to claim 11, wherein the program code further comprises:
queue code configured to cause at least one of the at least one processor to receive queue information transmitted from a item preparation terminal;
queue determination code configured to cause at least one of the at least one processor to determine, based on the order queue information, whether the item preparation terminal receives a new order after receiving the order; and
wherein the interval code is further configured to cause at least one of the at least one processor to obtain the first duration and the second duration based on the item preparation terminal receiving the new order.

15. The apparatus according to claim 11, wherein the order code is further configured to cause at least one of the at least one processor to:
display an order generation sub-area on the navigation interface based on the user operation on the order control;
generate configuration information of the order based on a user configuration operation in the order generation sub-area;
transmit the configuration information to an item preparation terminal based on a user confirmation operation on the configuration information;
receive order confirmation information from the item preparation terminal; and
generate and display the order information based on the order confirmation information.

16. The apparatus according to claim 15, wherein the order code is further configured to cause at least one of the at least one processor to:
display, on the navigation interface based on the user configuration operation, information about a plurality of candidate item preparation terminals located around the navigation destination;
determine the item preparation terminal based on a user selection operation on the plurality of candidate item preparation terminals;
display information about a plurality of candidate items provided from the item preparation terminal;
determine the target item based on a user selection operation on the plurality of candidate items; and
generate the configuration information based on the item preparation terminal and the target item.

17. The apparatus according to claim 15, wherein the order code is further configured to cause at least one of the at least one processor to:
display information about a plurality of candidate items based on the configuration operation;
determine the target item based on a selection operation of the user on the plurality of candidate items; and
generate the configuration information based on the target item; and
determine at least one candidate item preparation terminal as the item preparation terminal, based on at least one of the following conditions:
the at least one candidate item preparation terminal matches a type of the target item, or
the at least one candidate item preparation terminal is first to return order confirmation data among a plurality of candidate item preparation terminals;
transmit, based on the user confirmation operation, the configuration information to the at least one candidate item preparation terminal.

18. The apparatus according to claim 11, wherein the program code further comprises:
confirmation code configured to cause at least one of the at least one processor to transmit secondary confirmation information to the item preparation terminal based on a confirmation operation on the preparation state,
wherein the secondary confirmation information indicates that the user has reconfirmed the preparation of the target item.

19. The apparatus according to claim 11, wherein the program code further comprises:
destination code configured to cause at least one of the at least one processor to determine a changed navigation destination based on a destination change operation during navigation; and
cancellation code configured to cause at least one of the at least one processor to display order cancellation prompt information based on a distance between the navigation destination and the changed navigation destination being greater than a first threshold.

20. A non-transitory computer-readable storage medium, storing computer code which, when executed by at least one processor, causes the at least one processor to at least:
display a navigation interface based on a navigation operation of a vehicle, the navigation interface comprising an order control configured to generate an order for a target item;
generate and display order information based on a user operation on the order control, the order information comprising a navigation destination inputted during the navigation operation; and
determine a first duration based on a real-time remaining travel time for the vehicle to arrive at the navigation destination;
determine a second duration based on a real-time preparation time and delivery time of the target item; and
generate and display a preparation state for indicating that the target item is in preparation, based on the first duration being less than or equal to the second duration.
